(19) United States
(12) Patent Application Publication
(10) Pub. No.: US 2016/0003995 A1
(43) Pub. Date: Jan. 7, 2016

(54) OPTICAL FILM, CIRCULARLY POLARIZING PLATE, AND ORGANIC ELECTROLUMINESCENT DISPLAY DEVICE

(71) Applicant: KONICA MINOLTA, INC., Chiyoda-ku, Tokyo (JP)

(72) Inventors: Yukihito NAKAZAWA, Hino-shi, Tokyo (JP); Midori KOGURE, Kobe-shi, Hyogo (JP); Norie TANIHARA, Kobe-shi, Hyogo (JP); Kenji MISHIMA, Chuo-ku, Tokyo (JP); Rieko REN, Kobe-shi, Hyogo (JP)

(73) Assignee: KONICA MINOLTA, INC., Chiyoda-ku, Tokyo (JP)

(21) Appl. No.: 14/770,339

(22) PCT Filed: Mar. 12, 2014
(86) PCT No.: PCT/JP2014/056422

§ 371 Date: Aug. 25, 2015

(30) Foreign Application Priority Data
Mar. 21, 2013 (JP) 2013-057528

(51) Int. Cl. G02B 5/30; G02B 1/111; G02B 1/04

(52) U.S. Cl. CPC G02B 5/3083; G02B 1/04; G02B 1/111

(57) ABSTRACT

An optical film includes a cellulose derivative, the film having an in-plane retardation Ro₅₅₀ within 120 to 160 nm measured at 550 nm wavelength, and a ratio Ro₄₅₀/Ro₅₅₀ of in-plane retardations Ro₄₅₀ and Ro₅₅₀ within 0.65 to 0.99, respectively, measured at 450 and 550 nm wavelengths, under a 23° C. atmosphere with a relative humidity of 55%, wherein, substituents of glucose skeletons of the cellulose derivative satisfy: part of the substituents have multiple bonds, and the average degree of substitution of the substituents having multiple bonds is within 0.1 to 3.0 per glucose skeleton unit; the maximum absorption wavelength of the substituents having multiple bonds is within 220 to 400 nm; and at least part of the substituents in the glucose skeletons form ether bonds with the glucose skeletons, and the average degree of substitution of the substituents having ether bonds is within 1.0 to 3.0 per glucose skeleton unit.

### TECHNICAL FIELD

The present invention relates to an optical film that retards the phase of wide-band visible light by λ/4 and maintains stable performance in various environments of usage, and to a circularly polarizing plate and an organic electroluminescent display device, each including the optical film.

### BACKGROUND ART

Liquid crystal display devices, which are common display devices, are required to have high display performance and durability and expected to display images in excellent contrast and tone balance at a wide viewing angle. Such requirements have been met through the use of liquid crystal panels conforming to various display modes for liquid crystal display devices, for example, the VA (vertical alignment) mode, the OCB (optically compensated bend) mode, and the IPS (in-plane switching) mode. Such liquid crystal panels have wider viewing angles and higher display performance compared to those of liquid crystal panels conforming to the conventional TN (twisted nematic) mode.

Along with the increasing demand for energy efficiency, there also has been an increasing demand for display devices with wide viewing angles and high display performance. In such view, display devices including organic electroluminescent (organic EL) backlights have been drawing attention as next-generation display devices conforming to a new display mode.

An organic EL display device includes pixels provided with light sources that can be independently turned on or off. Thus, power consumption is low compared to that of liquid crystal display devices, which include backlights that are always turned on during image display. The control of transmission and non-transmission of light through each pixel in an image displayed on liquid crystal display devices involves a liquid crystal cell and polarizers disposed on both sides of the liquid crystal cell; whereas organic EL display devices do not require such a configuration because images can be formed through turning on and off the light sources, and thus can have significantly sharp front contrast and a wide viewing angle. In particular, the use of organic EL elements of the colors blue (B), green (G), and red (R) eliminates the need for color filters, which are essential for liquid crystal display devices; thus, organic EL display devices are expected to achieve higher contrast.

A typical organic EL display device includes a reflector having a mirror surface on the surface opposite to the light-extracting surface in the form of a highly reflective metal material serving as an electrode layer constituting the cathode or a separate metal plate serving as a reflector, to efficiently transmit light from a light-emitting layer to the viewed surface.

Unfortunately, unlike liquid crystal display devices, organic EL display devices do not include crossed Nicol polarizers; thus, external light is reflected by the light-extracting reflectors and forms a reflection, causing a significant decrease in contrast in a high brightness environment.

To solve such a problem, for example, a countermeasure is disclosed involving a circularly polarizing element for prevention of reflection of external light by a mirror surface (for example, refer to Patent Document 1). The circularly polarizing element described in Patent Document 1 includes an absorptive linear polarizer and a λ/4 retarder film, which are laminated such that their optical axes intersect at 45° or 135°.

A conventional retarder can adjust the retardation of a monochrome light beam to λ/4 or λ/2 of the wavelength of the light beam, but converts white light, which consists of combined waves of various visible light beams, into a spectrum of colored light polarized in accordance with the different wavelengths. This is because the material of the retarder exhibits wavelength dispersion corresponding to the phase difference.

To solve such a problem, various wideband retarders have been studied to achieve uniform retardation of light beams over a wide wavelength band. For example, a retarder includes a λ/4 wave plate that retards birefringent light by ¼ of the wavelength and a λ/2 wave plate that retards birefringent light by ½ of the wavelength, which are bonded together such that their optical axes intersect (for example, refer to Patent Document 2).

The production of the retarders described above requires a complicated step of adjusting the optical direction (optical axis or slow axis) of two polymeric films and a step of bonding multiple films with an adhesive layer, which hinders the advantage of organic EL display devices of being thin; thus, there is a need for the development of a wideband λ/4 retarder having a non-laminated single layer configuration.

Similar to the liquid crystal display device, an absorptive linear polarizer element in a circularly polarizing plate described above is typically composed of polyvinyl alcohol (hereinafter abbreviated as PVA) containing dichroic pigments and stretched to a length much greater than the original length; such a polarizer film is readily affected by the external environment, and thus requires a protective film. A widely used protective film for polarizer elements is composed of cellulose, for example, cellulose ester, which has excellent adhesiveness to PVA in the form of a polarizer element and high total light transmittance. Thus, the polarizer includes a polarizer element and polarizer protective films disposed on both sides of the polarizer element, and must also include a λ/4 retarder film so as to function as a circularly polarizing plate.

The λ/4 retarder film disposed on the polarizer protective film causes the retardation to deviate from λ/4, which is a desired optical property, due to the slight retardation ability of the polarizer protective film, and the increased number of components causes an increase in the thickness; thus, there is a demand for the development of an optical film that can function as both a polarizer protective film and a wideband λ/4 retarder.

A technique for producing a monolayer wideband λ/4 retarder film is disclosed. The λ/4 retarder film is produced through uniaxial stretching of a copolymer film composed of polymerized monomers having positive refractive-index anisotropy and monomers having negative birefringence (for example, refer to Patent Document 3). The uniaxially stretched polymeric film has inverse wavelength dispersion, which enables the production of a wideband λ/4 retarder from a single retarder film. Unfortunately, the polarizer protective film has poor adhesiveness to a polarizer element and insufficient total light transmittance.

The application of an optical film functioning both as an optical compensator and a polarizer protective film to a liquid crystal display device has been investigated. As such a film, an optical film consisting of a cellulose ester film having a predetermined retardation has been studied. For example, an optical film in the form of a retarder film conforming to the VA mode is disclosed. The retarder film is composed of cellulose ester having an in-plane retardation Ro of approximately 50 nm and a retardation Rt across the thickness of approximately 130 nm (for example, refer to Patent Document 4).

Cellulose ester is characterized in that a decrease in the degree of substitution relatively increases the phase difference but decreases the inverse wavelength dispersion, whereas an increase in the degree of substitution increases the inverse wavelength dispersion but decreases the retardation. Thus, a monolayer wideband λ/4 retarder can only be produced with a large thickness.

Other techniques have been investigated for an enhancement in the retardation and the wavelength dispersion of a film through the addition of additives, such as retardation enhancers and wavelength dispersion adjusters, to cellulose esters. Unfortunately, a large amount of additives impairs the quality of the film, causing a decrease in durability and transparency; thus, a solution to this drawback is required.

To solve the issues described above, a technique has been studied for the enhancement in the wavelength dispersion of a cellulose ester film through introduction of specific aromatic ester groups to cellulose ester (for example, refer to Patent Document 5). The technique proposed in Patent Document 5 can freely control the wavelength dispersion of a cellulose ester film without causing a decrease in the retardation ability.

The inventors have conducted an extensive study on the technique proposed in Patent Document 5 and have identified a problem of unevenness in tone and reflection of displayed images that occurs depending on the use environment when a wideband λ/4 retarder film is used as a circularly polarizing plate for an organic EL display device, which is produced through control of the substituents of cellulose ester described in Patent Document 5 so as to adjust retardation and wavelength dispersibility corresponding to phase difference. An organic EL display device was particularly prone to the problem described above when humidity fluctuated in the use environment; thus, the need for immediate measures for improvement was apparent.

### RELATED ART DOCUMENTS

### Patent Documents

Patent Document 1: Japanese Unexamined Patent Application Publication No. 8-321381
Patent Document 2: Japanese Unexamined Patent Application Publication No. 10-68816
Patent Document 3: International Publication WO2000/026705
Patent Document 4: Japanese Unexamined Patent Application Publication No. 2007-47537
Patent Document 5: Japanese Unexamined Patent Application Publication No. 2008-95026

### SUMMARY OF THE INVENTION

### Problems to be Solved by the Invention

An object of the present invention, which has been conceived in light of the problems described above, is to provide an optical film of a circularly polarizing plate, which serves as an antireflective layer in an organic electroluminescent display device, that can retard visible light in a wide range by substantially λ/4, exhibits a reduced variation in optical performance under variable humidity, and functions as a protective film for a polarizer; a circularly polarizing plate including the optical film; and an organic electroluminescent display device including the circularly polarizing plate as an antireflective component.

### Means for Solving the Problems

The inventors have conducted extensive investigation on an optical film comprising a cellulose derivative, the optical film having an in-plane retardation Ro₅₅₀ measured at a wavelength of 550 nm within the range of 120 to 160 nm, and a ratio Ro₄₅₀/Ro₅₅₀ of in-plane retardations Ro₄₅₀ and Ro₅₅₀ respectively measured at wavelengths of 450 and 550 nm within the range of 0.65 to 0.99, under an atmosphere of a temperature of 23° C. and a relative humidity of 55% and have discovered that an optical film that contains substituents of glucose skeletons of a cellulose derivative that satisfy Requirements (a) to (c) described below can retard visible light in a wide range by substantially λ/4, exhibits reduced variation in optical performance under variable humidity, and functions as a protective film for a polarizer.

The objects of the present invention can be achieved through the following means.

1. An optical film including:

a cellulose derivative, the optical film having an in-plane retardation Ro₅₅₀ within a range of 120 to 160 nm measured at a wavelength of 550 nm, and a ratio Ro₄₅₀/Ro₅₅₀ of in-plane retardations Ro₄₅₀ and Ro₅₅₀ within a range of 0.65 to 0.99 respectively measured at wavelengths of 450 and 550 nm, under an atmosphere of a temperature of 23° C. and a relative humidity of 55%,

wherein,

substituents of glucose skeletons of the cellulose derivative satisfy the following Requirements (a) to (c):

(a) part of the substituents have multiple bonds, and the average degree of substitution of the substituents having multiple bonds is within a range of 0.1 to 3.0 per glucose skeleton unit;

(b) the maximum absorption wavelength of the substituents having multiple bonds is within a range of 220 to 400 nm; and

(c) at least part of the substituents in the glucose skeletons form ether bonds with the glucose skeletons, and the average degree of substitution of the substituents having ether bonds is within a range of 1.0 to 3.0 per glucose skeleton unit.

2. The optical film described in the item 1, wherein the average degree of substitution of the substituents forming ether bonds with the glucose skeletons is within a range of 1.7 to 3.0 per glucose skeleton unit.
3. The optical film described in the item 1 or 2, wherein the average degree of substitution of the substituents having multiple bonds is within a range of 0.2 to 3.0 per glucose skeleton unit.
4. The optical film described in any one of the items 1 to 3, wherein the average degree of substitution of the substituents having multiple bonds at positions 2, 3, and 6 of the glucose skeletons satisfies Expression (1):

0<(average degree of substitution at position 2+average degree of substitution at position 3)−average degree of substitution at position 6 Expression (1)

5. The optical film described in any one of the items 1 to 4, wherein the substituents forming ether bonds with glucose skeletons include aliphatic hydrocarbon groups forming ether bonds with the glucose skeletons.
6. The optical film described in the item 5, wherein the aliphatic hydrocarbon groups forming ether bonds with the glucose skeletons include nonsubstituted aliphatic hydrocarbon groups having a carbon number within a range of 1 to 6.
7. The optical film described in any one of the items 1 to 6, wherein at least part of the substituents forming multiple bonds with the glucose skeletons form ether bonds with the glucose skeletons.
8. The optical film described in any one of the items 1 to 7, wherein the substituents having multiple bonds have an aromatic structure.
9. The optical film described in any one of the items 1 to 8, wherein the optical film has thickness within a range of 20 to 60 μm.
10. The optical film described in any one of the items 1 to 9, wherein the optical film has a large length and a slow axis within a range of 40° to 50° from the longitudinal direction.
11. A circularly polarizing plate including:

the optical film described in any one of the items 1 to 10 and a polarizer element, the optical film and the polarizer element being bonded together.

12. An organic electroluminescent display device including:

the circularly polarizing plate described in the item 11.

### Advantageous Effects of the Invention

Through the means of the present invention, provide are an optical film that can retard visible light in a wide range by substantially λ/4, exhibits a reduced variation in optical performance (tone and reflectivity) under variable humidity, and functions as a protective film for a polarizer; a circularly polarizing plate including the optical film; and an organic electroluminescent display device including the circularly polarizing plate as an antireflective component.

The configurations according to the present invention provide solutions to the problems described above for the following presumed reasons.

The inventors have conducted extensive investigation on the causes of the problem of unevenness in tone and reflection of displayed images that occurs depending on the use environment when a wideband λ/4 retarder is used as a circularly polarizing plate for an organic EL display device, which is produced through control of the substituents of cellulose ester so as to adjust retardation and wavelength dispersibility corresponding to phase difference.

If an optical film having a configuration according to Patent Document 5 is adjusted to have an in-plane retardation of λ/4 and an inverse wavelength dispersion, cellulose ester provides two functions: retardation adjustment for achieving a large in-plane retardation and wavelength dispersion adjustment for achieving inverse wavelength dispersion. As a result, even slight absorption of moisture by the cellulose ester probably causes synergistic variations in the retardation and the wavelength dispersion.

The variation in retardation of an optical film due to absorption of moisture is probably caused by water molecules coordinated to the ester groups of the cellulose ester, and the variations in retardation and wavelength dispersion are probably caused by water molecules coordinated to the ester groups containing aromatic rings contributing to the adjustment of wavelength dispersion and to non-aromatic ester groups contributing to the retardation. The sharp contrast and the high image quality of organic EL display devices emphasize unevenness in tone and reflection due to slight variations in retardation and wavelength dispersion that are unrecognizable in liquid crystal display devices.

If a λ/4 retarder film for a circularly polarizing plate of an organic EL display device is prepared in accordance with the techniques disclosed in Patent Document 5, the problems described above would be significantly notable due to the reasons described above.

The inventors have further conducted an intensive study and have discovered that the introduction of substituents having multiple bonds (e.g., double or triple bonds) and a maximum absorption wavelength within the range of 220 to 400 nm to a cellulose derivative at an average degree of substitution within the range of 0.1 to 3.0 establishes inverse wavelength dispersion of the retardation, and the introduction of ether groups at an overall average degree of substitution within the range of 1.0 to 3.0 to the cellulose derivative can effectively reduce a variation in retardation, which is mainly caused by the water molecules being aligned with the ester groups, without a decrease in the retardation ability; this can yield an optical film having a wideband λ/4 in-plane retardation, and an organic EL display device including the optical film can sufficiently reduce unevenness in tone and reflection of the display device.

### BRIEF DESCRIPTION OF DRAWINGS

FIG. 1 is a schematic view illustrating the contraction rate in oblique stretching.

FIG. 2 illustrates an example rail pattern of an oblique stretching machine that can be used in a method of producing a λ/4 retarder film according to the present invention.

FIG. 3A illustrates an example method of producing a λ/4 retarder film (an example method of feeding a long-film from a roll and obliquely stretching the film) according to an embodiment of the present invention.

FIG. 3B illustrates another example method of producing a λ/4 retarder film (an example method of feeding a long-film from a roll and obliquely stretching the film) according to an embodiment of the present invention.

FIG. 3C illustrates another example method of producing a λ/4 retarder film (an example method of feeding a long-film from a roll and obliquely stretching the film) according to an embodiment the present invention.

FIG. 4A illustrates an example method of producing a λ/4 retarder film (an example method of continuously and obliquely stretching a long film without reeling the film) according to an embodiment of the present invention.

FIG. 4B illustrates an example method of producing a λ/4 retarder film (an example method of continuously and obliquely stretching a long film without reeling the film) according to an embodiment of the present invention.

FIG. 5 is a cross-sectional schematic view of an example configuration of an organic electroluminescent display device according to the present invention.

### EMBODIMENTS FOR CARRYING OUT THE INVENTION

An optical film according to the present invention contains a cellulose derivative of which the in-plane retardation Ro₅₅₀ measured at a wavelength of 550 nm is within the range of 120 to 160 nm, and the ratio of in-plane retardations Ro₄₅₀/Ro₅₅₀ is within the range of 0.65 to 0.99, where the in-plane retardations Ro₄₅₀ and Ro₅₅₀ are measured at wavelengths of 450 and 550 nm, respectively, under an atmosphere of a temperature of 23° C. and a relative humidity of 55%; and substituents of the glucose skeletons of the cellulose derivative are characterized in that they satisfy Requirements (a) to (c).

Such technical characteristics are common to the first to 12th aspects of the present invention.

The intended advantages of the present invention can be achieved through embodiments of the present invention in which the average degree of substitution of substituents forming ether bonds with the glucose skeletons is preferably within the range of 1.7 to 3.0 per glucose skeleton unit, in view of low variations in tone and reflectivity of an organic EL display device due to a variation in humidity.

Cellulose derivatives containing substituents that consist mostly of ester groups readily cause a variation in birefringence due to interaction between the ester groups and water, and thus promote variations in tone and reflectivity under variable humidity. The introduction of ether groups enhances the hydrophobicity of the cellulose derivatives, and the variations in tone and reflectivity under variable humidity are reduced probably because the ether groups have low interaction with water, unlike ester groups, and thus are less likely to cause a variation in birefringence.

The average degree of substitution of substituents having multiple bonds, e.g., double or triple bonds, is preferably within the range of 0.2 to 1.7 per glucose skeleton unit, in view of low variations in tone and reflectivity of an organic EL display device under external light.

The average number of substituents having multiple bonds, e.g., double or triple bonds, at positions 2, 3, and 6 of the glucose skeletons preferably satisfies Formula (1), in view of production stability.

Satisfying Formula (1) promotes the wavelength dispersion control by substituents having multiple bonds; thus, a small degree of substitution of substituents having multiple bonds can achieve sufficient wavelength dispersion control. This can reduce the reaction time for introduction of substituents having multiple bonds into glucose units; thus, the elimination of other substituents can be reduced so as to enhance the production stability. Furthermore, the degree of substitution of the substituents having multiple bonds can be small, and thus the number of hydroxy groups per glucose skeleton unit can be increased. As a result, the brittleness of the film due to enhanced hydrogen bonding between resins can be reduced.

The substituents forming ether bonds with the glucose skeletons are preferably aliphatic hydrocarbon groups forming ether bonds with the glucose skeletons, in view of low variations in tone and reflectivity of an organic EL display device under variable humidity.

Ether bonding of aliphatic hydrocarbon groups enhances the hydrophobicity of the cellulose derivatives and can reduce the water intruding the optical film. This probably reduces variations in tone and reflectivity under variable humidity.

The aliphatic hydrocarbon groups forming ether bonds with the glucose skeletons are preferably nonsubstituted aliphatic hydrocarbon groups having a carbon number within the range of 1 to 6, in view of low variations in tone and reflectivity in an organic EL display device with a small film thickness under external light.

A long aliphatic hydrocarbon group containing more than six carbons might need an increased thickness in order to reduce the orientation of the resin and establish an in-plane retardation required for a λ/4 retarder film.

At least part of the substituents forming multiple bonds with the glucose skeletons preferably form ether bonds with the glucose skeletons, in view of low variations in tone and reflectivity of an organic EL display device under variable humidity.

Acyl substituents having multiple bonds, i.e., ester bonds, significantly contribute to wavelength dispersion; thus, even a slight variation in birefringence due to an interaction with water readily causes variations in tone and reflectivity. Thus, replacement of at least part of the substituents having multiple bonds with ether groups can significantly reduce the variations in tone and reflectivity.

The maximum absorption wavelength of the substituents having multiple bonds is preferably within the range of 220 to 300 nm, in view of enhancement in adhesiveness and viscosity of UV-curable adhesives or UV-curable pressure-sensitive adhesives used in the production of a polarizer through bonding of an optical film and a polarizer element, and enhancement in transparency of visible light.

Specifically, a maximum absorption of 300 nm or less has an absorption edge outside of the visible light range and can prevent coloring of the optical film. Such a maximum absorption does not affect the adhesiveness or viscosity of the UV-curable adhesive or the UV-curable pressure-sensitive adhesive that is cured as a result of irradiation with light having a wavelength within the range of 300 to 400 nm and can enhance the adhesiveness with the polarizer element or the layer to which the polarizer element is bonded.

The term “maximum absorption wavelength” according to the present invention refers to the wavelength that achieves the largest molar adsorption coefficient in a dichloromethane solution for substituents CH₃—O—R, CH₃—O—CO—R, CH₃—O—CONH—R, and CH₃—O—CO—O—R, where R represents a substituent having a multiple bond.

The substituents having multiple bonds preferably have aromatic groups, for high productivity.

Substituents having multiple bonds having an aromatic structure that exhibits a large variation in birefringence depending on the wavelength can effectively control wavelength dispersion. Thus, sufficient wavelength dispersion can be achieved even with a small degree of substitution of substituents having multiple bonds. This leads to a reduction in reaction time for introduction of the substituents having multiple bonds into glucose units, and thus, a reduction in the effect of elimination of other substituents to enhance the production stability. Furthermore, the degree of substitution of the substituents having multiple bonds can be small, and thus the number of hydroxy groups per glucose skeleton unit can be increased. As a result, the brittleness of the film due to enhanced hydrogen bonding between resins can be reduced.

Preferably, the thickness of the optical film is within the range of 20 to 60 μm, or the optical film is long and the slow axis is disposed within the range of 40° to 50° from the longitudinal direction.

Components and embodiments of the present invention will now be described in detail. It should be noted that, throughout the specification, the term “to” indicating the numerical range is meant to be inclusive of the lower and upper limits represented by the numerals given before and after the term.

An optical film, a circularly polarizing plate, and an organic electroluminescent display device according to the present invention will now be described in detail.

### <<Optical Film>>

An optical film according to the present invention contains a cellulose derivative of which the in-plane retardation Ro₅₅₀ measured at a wavelength of 550 nm is within the range of 120 to 160 nm, and the ratio of in-plane retardations Ro₄₅₀/Ro₅₅₀ is within the range of 0.65 to 0.99, where in-plane retardations Ro₄₅₀ and Ro₅₅₀ are measured at wavelengths of 450 and 550 nm, respectively, under an atmosphere of a temperature of 23° C. and a relative humidity of 55%; and substituents of the glucose skeletons of the cellulose derivative are characterized in that they satisfy the following Requirements: (a) part of the substituents have multiple bonds and the average degree of substitution of the substituents having multiple bonds per glucose skeleton unit is within the range of 0.1 to 3.0; (b) the maximum absorption wavelength of the substituents having multiple bonds is within the range of 220 to 400 nm; and (c) at least part of the substituents in the glucose skeletons form ether bonds with the glucose skeletons, and the average degree of substitution of the substituents having ether bonds is within the range of 1.0 to 3.0 per glucose skeleton unit.

The optical film according to the present invention preferably is a long film that has a slow axis disposed within the range of 40° to 50° from the longitudinal direction or has a thickness within the range of 20 to 60 μm.

The optical film according to the present invention preferably contains a cellulose derivative as a resin component and has a slow axis disposed within a range of 40° to 50° from the longitudinal direction. An example process of disposing the slow axis within the range of 40° to 50° from the longitudinal direction is oblique stretching of a deposited unstretched film, as described below. In this embodiment, the term “optical film” refers to a film having an optical ability of retarding transmitted light by a predetermined amount; examples of such optical ability include conversion of linearly polarized light of a specific wavelength to elliptically or circularly polarized light and conversion of elliptically or circularly polarized light to linearly polarized light. In particular, the term “λ/4 retarder film” refers to an optical film having a property that shifts the in-plane phase of light having a predetermined wavelength (normally in the visible light range) by approximately ¼.

### [Property of Optical Film]

An optical film according to the present invention (hereinafter also referred to as “retarder film”) preferably is a wideband λ/4 retarder film that retards light within the visible range by approximately ¼ of the wavelength so as to acquire circularly polarized light.

An in-plane retardation Ro_{λ} and a retardation Rt_{λ} across the thickness of a retarder film according to the present invention are represented by Expressions (i) below. The character λ represents the wavelength (nm) used for the measurement of retardation. The retardation according to the present invention can be calculated with Expressions (i) after measuring the birefringence at each wavelength with, for example, Axoscan manufactured by Axometrics Inc., under an atmosphere of 23° C. and a relative humidity of 55%.

Ro_{λ}=(n_{xλ}−n_{yλ})×d, and

Rt_{λ}=[(n_{xλ}+n_{yλ})/2−n_{zλ}]×d, Expression (i)

where λ represents the wavelength (nm) used for the measurement, nₓ, n_{y}, and n_{z} are measured under an atmosphere of 23° C. and 55% RH, nₓ represents the in-plane maximum refractive index of the film (refractive index in the direction of the slow axis), n_{y} represents the in-plane refractive index in the direction orthogonal to the slow axis, n_{z} represents the refractive index across the thickness orthogonal to the film plane, and d represents the thickness (nm) of the film.

The retarder film according to the present invention has an in-plane retardation Ro₅₅₀ measured at a wavelength of 550 nm within the range of 120 to 160 nm, and the ratio of in-plane retardations Ro₄₅₀/Ro₅₅₀ is within the range of 0.65 to 0.99, where the in-plane retardations Ro₄₅₀ and Ro₅₅₀ are measured at wavelengths of 450 and 550 nm, respectively, where Ro_{λ} represent an in-plane retardation of a wavelength λ (nm) in the retarder film.

The retardation Ro₅₅₀ according to the present invention is within the range of 120 to 160 nm, preferably 130 to 150 nm, and more preferably 135 to 145 nm. An optical film according to the present invention having an Ro₅₅₀ within the range of 120 to 160 nm achieves a retardation of approximately ¼ of the wavelength measured at a wavelength of 550 nm. A circularly polarizing plate composed of such an optical film can be installed in an organic EL display device, for example, so as to prevent reflection of indoor lighting and enhance black display characteristic in bright environments.

The ratio of in-plane retardations Ro₄₅₀/Ro₅₅₀ where the in-plane retardations Ro₄₅₀ and Ro₅₅₀ are measured at wavelengths of 450 and 550 nm, respectively, is within the range of 0.65 to 0.99, preferably, 0.70 to 0.94, more preferably, 0.75 to 0.89. If Ro₄₅₀/Ro₅₅₀ is within the range of 0.65 to 0.99, the retardation exhibits appropriate inverse wavelength dispersion. A long circularly polarizing plate can achieve high antireflective effects against wide-band light.

For the retardation Rt_{λ} across the thickness, the retardation Rt₅₅₀ measured at a wavelength of 550 nm is preferably within the range of ±0 to ±200 nm, more preferably ±0 to ±150, most preferably ±0 to ±100 nm. An Rt₅₅₀ within the range of ±0 to ±200 nm can prevent a variation in hue on a large screen at an oblique viewing angle.

### [Cellulose Derivative]

The cellulose derivative in the optical film according to the present invention has glucose skeletons containing substituents satisfying Requirements (a) to (c) described below.

According to the First Requirement (a) of the substituents of the glucose skeletons of the cellulose derivative according to the present invention, part of the substituents have multiple bonds, and the average degree of substitution of the substituents having multiple bonds is within the range of 0.1 to 3.0 per glucose skeleton unit. The average degree of substitution of the substituents having multiple bonds is preferably within the range of 0.2 to 1.7 per glucose skeleton unit. The average degree of substitution of the substituents having multiple bonds at positions 2, 3, and 6 of the glucose skeletons preferably satisfies the relationship: 0<(average degree of substitution at position 2+average degree of substitution at position 3)−average degree of substitution at position 6. Furthermore, at least part of the substituents having multiple bonds in the glucose skeletons preferably form ether bonds with the glucose skeletons and the substituents having multiple bonds preferably have an aromatic structure. The multiple bonds in the present invention has a multiplicity of two or more, for example, are double or triple bonds.

According to the Second Requirement (b) of the substituents of the glucose skeletons of the cellulose derivative according to the present invention, the maximum absorption wavelength of the substituents having multiple bonds is within the range of 220 to 400 nm. Furthermore, the maximum absorption wavelength of the substituents having multiple bonds is preferably within the range of 220 to 300 nm.

According to the Third Requirement (c) of the substituents of the glucose skeletons of the cellulose derivative according to the present invention, at least part of the substituents in the glucose skeletons form ether bonds with the glucose skeletons, and the average degree of substitution of the substituents having ether bonds is within the range of 1.0 to 3.0 per glucose skeleton unit. Furthermore, the average degree of substitution of the substituents forming ether bonds with the glucose skeletons is preferably within the range of 1.7 to 3.0 per glucose skeleton unit. The substituents forming ether bonds with the glucose skeletons preferably are aliphatic hydrocarbon groups forming ether bonds with the glucose skeletons, and the aliphatic hydrocarbon groups forming ether bonds with the glucose skeletons are preferably nonsubstituted aliphatic hydrocarbon groups having a carbon number within the range of 1 to 6.

That is, part of the hydroxyl groups at positions 2, 3, and 6 of the glucose skeletons (β-glucose rings) in the cellulose derivative according to the present invention are substituted with the substituents having multiple bonds, at least part of the substituents in the cellulose derivative are substituted with substituents forming ether bonds with the glucose skeletons, and the degree of substitution of such substituents satisfies a predetermined condition.

The cellulose derivative according to the present invention will now be described in details.

The glucose skeleton of the cellulose derivative according to the present invention is composed of glucose skeleton units represented by Formula (1) below:

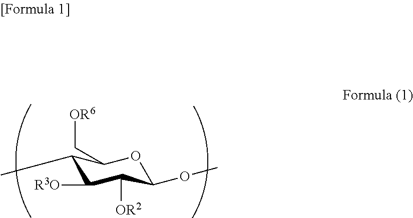

In Formula (1), R² represents a substituent at position 2 of a glucose skeleton, R³ represents a substituent at position 3 of a glucose skeleton, and R⁶ presents a substituent at position 6 of a glucose skeleton. R², R³, and R⁶ may each be a hydrogen atom or any substituent that satisfies Requirements (a) to (c) described above.

### (Substituent Having Multiple Bonds)

A cellulose derivative according to the present invention has substituents having multiple bonds. The substituents having multiple bonds may be any substituent including at least one double bond or triple bond and having a maximum absorption wavelength within the range of 220 to 400 nm, and, for example, be substituents having an aromatic structure. The substituents may be aromatic groups having a combination of double and triple bonds. The aromatic groups may form bonds with electron-withdrawing or electron-releasing functional groups. Electron-releasing groups are preferably bonded to aromatic groups so as to enhance wavelength dispersion.

The cellulose derivative according to the present invention has substituents having multiple bonds of which the average degree of substitution is within the range of 0.1 to 3.0 per glucose skeleton unit. The term “average degree of substitution” refers to the average of the total number of substituents having multiple bonds at positions 2, 3, and 6 of the glucose skeletons in the total amount of cellulose derivatives.

With reference to Formula (1), the substituents R², R³, and R⁶ having multiple bonds can be represented as —R, —OC—R, —OCNH—R, and —OC—O—R, for example, where R represents an aromatic group. If the substituents R², R³, and R⁶ having multiple bonds each represent —R, the substituents form ether bonds with the glucose skeletons, and thus the substituents having multiple bonds include substituents forming ether bonds with the glucose skeletons according to the present invention.

The aromatic group according to the present invention is defined as an aromatic compound in Rikagaku Jiten, (Dictionary of Physical and Chemical Science) (Iwanami Shoten, Publishers), Fourth Edition, p. 1208. The aromatic group according to the present invention may be an aromatic hydrocarbon group or an aromatic heterocyclic group, preferably an aromatic hydrocarbon group.

The aromatic hydrocarbon group preferably has a carbon atom number of 6 to 24, more preferably 6 to 12, most preferably 6 to 10. Examples of aromatic hydrocarbon groups include phenyl, naphthyl, anthryl, biphenyl, and terphenyl groups, preferably phenyl, naphthyl, and biphenyl groups, more preferably a phenyl group.

An aromatic heterocyclic group preferably contains at least one of an oxygen atom, a nitrogen atom, and a sulfur atom. Examples of hetero rings include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzthiazole, benzotriazole, and tetrazaindene. The aromatic heterocyclic group is preferably a pyridyl group, a thiophenyl group, a triazinyl group, or a quinolyl group.

Examples of aromatic groups forming ether bonds with glucose skeletons include benzyl ether, 4-phenyl benzyl ether, 4-thiomethyl benzyl ether, 4-methoxybenzyl ether, 2,4,5-trimethyl benzyl ether, and 2,4,5-trimethoxybenzyl ether.

Other examples of aromatic groups forming ether bonds with glucose skeletons include 2-thienyl ether, 3-thienyl ether, 4-thiazolyl ether, 2-thiazolyl ether, 2-furyl ether, 3-furyl ether, 4-oxazolyl ether, 2-oxazolyl ether, 2-pyrrolyl ether, 3-pyrrolyl ether, 3-imidazolyl ether, 2-triazolyl ether, 1-pyrrolyl ether, 1-imidazolyl ether, 1-pyrazolyl ether, 2-pyridyl ether, 3-pyridyl ether, 4-pyridyl ether, 2-pyrazyl ether, 4-pyrimidyl ether, 2-pyrimidyl ether, 2-quinolyl ether, 2-quinoxalyl ether, 7-quinolyl ether, 9-carbazolyl ether, 2-benzothienyl ether, 2-benzofuryl ether, 2-indolyl ether, 2-benzothiazolyl ether, 2-benzoxazolyl ether, and 2-benzimidazolyl ether.

Preferable examples of aromatic acyl groups include benzoyl groups, phenyl benzoyl groups, 4-methylbenzoyl groups, 4-thiomethylbenzoyl groups, 4-methoxybenzoyl groups, 4-heptylbenzoyl groups, 2,4,5-trimethoxybenzoyl groups, 2,4,5-trimethylbenzoyl groups, 3,4,5-trimethoxybenzoyl groups, and naphthoyl groups.

Other examples of aromatic acyl groups include 2-thiophene carboxylic ester, 3-thiophene carboxylic ester, 4-thiazole carboxylic ester, 2-thiazole carboxylic ester, 2-furan carboxylic ester, 3-furan carboxylic ester, 4-oxazole carboxylic ester, 2-oxazole carboxylic ester, 2-pyrrole carboxylic ester, 3-pyrrole carboxylic ester, 3-imidazole carboxylic ester, 2-triazole carboxylic ester, 1-pyrrole carboxylic ester, 1-imidazole carboxylic ester, 1-pyrazole carboxylic ester, 2-pyridine carboxylic ester, 3-pyridine carboxylic ester, 4-pyridine carboxylic ester, 2-pyrazine carboxylic ester, 4-pyrimidine carboxylic ester, 2-pyrimidine carboxylic ester, 2-quinoline carboxylic ester, 2-quinoxaline carboxylic ester, 7-quinoline carboxylic ester, 9-carbazole carboxylic ester, 2-benzothiophene carboxylic ester, 2-benzofuran carboxylic ester, 2-indole carboxylic ester, 2-benzothiazole carboxylic ester, 2-benzoxazole carboxylic ester, and 2-benzoimidazole carboxylic ester.

Such aromatic groups may further include substituents that preferably do not contain carboxy groups (—C(═O)O—). Carboxy groups enhance hydrophilicity and thus tend to increase the dependence of optical properties on humidity. Aromatic groups have aromatic sites that are preferably nonsubstituted or substituted by alkyl or aryl groups.

(Substituents Forming Ether Bonds with Glucose Skeletons)

The cellulose derivative according to the present invention has substituents forming ether bonds with glucose skeletons, which have an average degree of substitution within the range of 1.0 to 3.0 per glucose skeleton unit.

The substituents may be any substituent forming ether bonds with glucose skeletons, specifically, with reference to Formula (1), examples of the substituents R², R³, and R⁶ forming ether bonds with the glucose skeletons include aliphatic hydrocarbon groups and aromatic groups. R², R³, and R⁶ that are aromatic groups may be included in the substituents having multiple bonds, as described above.

The substituents forming ether bonds with glucose skeletons preferably are aliphatic hydrocarbon groups forming ether bonds with the glucose skeletons. The aliphatic hydrocarbon groups are preferably nonsubstituted aliphatic hydrocarbon groups, more preferably nonsubstituted aliphatic hydrocarbon groups having a carbon number of 1 to 6.

Nonsubstituted aliphatic hydrocarbon groups are aliphatic groups containing only carbon and hydrogen atoms, and may be any one of linear, branched, and cyclic chains. The aliphatic hydrocarbon groups are preferably alkyl groups, more preferably linear chain alkyl groups. The number of carbon atoms in an aliphatic hydrocarbon group is preferably 1 to 20, more preferably 1 to 12, most preferably 1 to 6. The aliphatic hydrocarbon groups are preferably linear chain alkyl groups having the number of carbon atoms mentioned above. The aliphatic hydrocarbon groups are more preferably methyl or ethyl groups.

Aliphatic hydrocarbon groups containing substituents preferably do not have substituents containing carboxy groups (—C(═O)O—). Carboxy groups enhance hydrophilicity, and thus tend to increase the dependence of optical properties on humidity. A specific example of an aliphatic hydrocarbon group containing substituents is a hydroxypropyl group.

According to the present invention, the term “average degree of substitution of substituents having ether bonds” refers to the average of the total number substituents forming ether bonds with glucose skeletons at positions 2, 3, and 6 of the glucose skeletons in the total amount of cellulose derivatives. A high average degree of substitution of substituents forming ether bonds with glucose skeletons efficiently reduces the adverse effects due to a variation in humidity, whereas a low average degree of substitution is less efficient. Thus, an average number of substituents forming ether bonds with glucose skeletons of 1.0 or more can reduce variations in retardation and wavelength dispersion under humid environments, and can reduce variations in black display and reflectivity of an organic electroluminescent display device.

### (Other Substituents)

Formula (1) may have substituents other than those having multiple bonds or those forming ether bonds with glucose skeletons, so long as Requirements (a) to (c) are satisfied.

Examples of such substituents R², R³, and R⁶ include aliphatic acyl groups.

An aliphatic acyl group consists of —(C═O)R, where R represents an aliphatic site. The aliphatic site may be any one of linear, branched, and cyclic chains. The number of carbon atoms in an aliphatic acyl group is preferably within the range of 1 to 20, more preferably 1 to 12, most preferably 1 to 6.

The aliphatic site of the aliphatic acyl group may contain one or more substituents.

The aliphatic acyl group is preferably nonsubstituted and preferably any one of acetyl group, propionyl group, and butyryl group.

The cellulose derivative according to the present invention can be produced with reference to a known method, for example, described in “Serurosu no Jiten (Dictionary of Cellulose)” (pp. 131-164) (Asakura Publishing Co. Ltd., 2000). Specifically, cellulose ether containing ether groups in substitution for part of the hydroxy groups at positions 2, 3, and 6 can be used as raw material, and the cellulose ether, which is made from acid chlorides or acid anhydrides in the presence of a base, such as pyridine, can be made from a known material cotton.

According to the present invention, the degree of substitution of the substituents in glucose skeletons can be determined by ¹H-NMR or ¹³C-NMR spectroscopic procedures described in “Cellulose Communication 6, 73-79 (1999)” and “Chirality 12(9), 670-674.”

### <<Various Additives for Optical Film>>

The optical film according to the present invention may contain various additives having various functions.

Any additive may be selected that does not impair the advantages of the present invention. Examples of such additives include retardation enhancers, wavelength-dispersion enhancers, anti-aging agents, UV absorbers, matting agents, and plasticizers.

Representative additives that are suitable for the optical film according to the present invention will now be described.

### (UV Absorber)

The optical film according to the present invention may contain a UV absorber.

Examples of UV absorbers include oxybenzophenones, benzotriazoles, salicylate esters, benzophenones, cyanoacrylates, and nickel complexes. Preferred is benzotriazoles, which cause less coloring. Preferred UV absorbers also include the UV absorbers described in Japanese Patent Application Laid-Open Nos. 10-182621 and 8-337574, and the polymeric UV absorbers described in Japanese Patent Application Laid-Open No. 6-148430. If an optical film according to the present invention is used as a protective film for a polarizer, other than a retarder film, it preferably contains a UV absorber having high absorbance for ultraviolet rays with a wavelength of 370 nm or less in view of prevention of degradation of the polarizer element and the organic EL element, and low absorbance for visible light of a wavelength of 400 nm or more in view of satisfactory display of the organic EL element.

Examples of the preferred benzotriazole UV absorber suitable in the present invention include, but should not be limited to, 2-(2′-hydroxy-5′-methylphenyl)benzotriazole, 2-(2′-hydroxy-3′,5′-di-t-butylphenyl)benzotriazole, 2-(2′-hydroxy-3′-t-butyl-5′-methylphenyl)benzotriazole, 2-(2′-hydroxy-3′,5′-di-t-butylphenyl)-5-chlorobenzotriazole, 2-[2′-hydroxy-3′-(3′,4′,5′,6′-tetrahydrophthalimidemethyl)-5′-methylphenyl]benzotriazole, 2,2-methylenebis[4-(1,1,3,3-tetramethylbutyl)-6-(2H-benzotriazole-2-yl)phenol], 2-(2′-hydroxy-3′-t-butyl-5′-methylphenyl)-5-chlorobenzotriazole, 2-(2H-benzotriazole-2-yl)-6-(linear or side-chain dodecyl)-4-methylphenol, and a mixture of octyl-3-[3-t-butyl-4-hydroxy-5-(chloro-2H-benzotriazole-2-yl)phenyl]propionate and 2-ethylhexyl-3-[3-t-butyl-4-hydroxy-5-(5-chloro-2H-benzotriazole-2-yl)phenyl]propionate.

The following commercially available products can also be used as preferred UV absorbers: Tinuvin 109, Tinuvin 171, Tinuvin 326, and Tinuvin 328 (products and trademarks of BASF Japan Ltd.).

The UV absorber should be added to the cellulose derivative in an amount within the range of preferably 0.1 to 5.0 mass %, more preferably 0.5 to 5.0 mass %.

### (Anti-Aging Agent)

The optical film according to the present invention may contain anti-aging agents as required, such as antioxidants, light stabilizers, peroxide decomposers, radical polymerization inhibitors, metal deactivators, acid scavengers, and amines. Examples of anti-aging agents are described in Japanese Patent Application Laid-Open Nos. 3-199201, 5-197073, 5-194789, 5-271471, and 6-107854. The content of an anti-aging agent is preferably within the range of 0.01 to 1 mass %, more preferably 0.01 to 0.2 mass % of the cellulose solution (dope) used in the production of an optical film, in view of an effect of the anti-aging agent and prevention of bleeding out of the anti-aging agent to the surface of the film. Examples of particularly preferred anti-aging agents include butylated hydroxytoluene (BHT) and tribenzylamine (TBA).

### (Matting Agent Particles)

The optical film according to the present invention preferably contains particles as a matting agent. Examples of such matting agent particles include silicon dioxide, titanium dioxide, aluminum oxide, zirconium oxide, calcium carbonate, calcium carbonate, talc, clay, fired kaolin, fired calcium silicate, hydrated calcium silicate, aluminum silicate, magnesium silicate, and calcium phosphate. Matting agent particles containing silicon are preferred for reduction in turbidity (haze); silicon dioxide is particularly preferred. The particles of silicon dioxide preferably have an average primary particle size within the range of 1 to 20 nm and an apparent specific weight of 70 g/L or more. The average primary particle size is more preferably within the range of 5 to 16 nm, in view of a reduction in haze in the optical film. The apparent specific weight is preferably within the range of 90 to 200 g/L, more preferably 100 to 200 g/L. A large apparent specific weight can provide a dispersion liquid with high concentration and thus is preferred for reducing haze and aggregation.

Normally such particles form secondary particles having an average particle size within the range of 0.05 to 2.0 μm. Such secondary particles are present in the form of aggregations of primary particles in the optical film and form irregularities within the range of 0.05 to 2.0 μm on the surface of the optical film. The average secondary particle size is preferably within the range of 0.05 to 1.0 μm, more preferably 0.1 to 0.7 μm, most preferably 0.1 to 0.4 μm. The size of the primary and secondary particles is determined by the diameter of a circumscribed circle of a particle in the optical film observed with a scanning electron microscope. The average particle size is determined through observation of 200 particles at different locations and calculation of the average particle size.

Examples of commercially available products of silicon oxide particles include Aerosil R972, R972V, R974, R812, 200, 200V, 300, R202, OX50, and TT600 (products and trademarks of Nippon Aerosil Co., Ltd.). Examples of commercially available products of zirconium oxide particles include Aerosil R976 and R811 (products and trademarks of Nippon Aerosil Co., Ltd.).

Aerosil 200V and Aerosil R972V contain silicon dioxide particles having an average primary particle size of 20 nm or less and an apparent specific weight of 70 g/L or more, and are particularly preferred for maintenance of low haze in the optical film and reduction of the friction coefficient of the optical film.

The matting agent particles are preferably prepared through the procedure described below and compounded to the optical film. That is, a solvent and matting agent particles are mixed by agitation to prepare a dispersion of matting agent particles in advance; this dispersion of matting agent particles is dissolved in various additive solutions, which are prepared separately and have a cellulose derivative concentration of less than 5 mass %; and each of the additive solutions is mixed with a main cellulose derivative dope.

The hydrophobic surfaces of the matting agent particles facilitate trap of hydrophobic additives on the surfaces of the matting agent particles. These trapped additives serve as cores and promote aggregation of the additives. Thus, preliminary preparation of a mixture of a relatively hydrophilic additive and a dispersion of matting agent particles and addition of a hydrophobic additive to this mixture can reduce aggregation of the additive particles on the surface of the matting agent particles. This preferably reduces haze in the optical film and light leakage in a black display mode of the organic EL display device including the optical film.

The dispersion of matting agent particles, the additive solution, and the cellulose derivative dope are preferably mixed with an inline mixer. Any mixing process may be used in the present invention. The silicon dioxide content in a solution of silicon dioxide particles dispersed in a solvent is preferably in the range of 5 to 30 mass %, more preferably 10 to 25 mass %, and most preferably 15 to 20 mass %. At a certain content of silicon dioxide in a solution, higher dispersion is preferred because of lower turbidity and reduction in haze and aggregation. The final content of the matting agent in the cellulose derivative dope is preferably within the range of 0.001 to 1.0 mass %, more preferably 0.005 to 0.5 mass %, and most preferably 0.01 to 0.1 mass %.

### [Production of Optical Film Containing Cellulose Derivative]

The optical film according to the present invention can be produced through any process. A preferred process is solvent casting (solution deposition). In solvent casting, an optical film is produced from a solution of a cellulose derivative dissolved in an organic solvent (hereinafter the solution is also referred to as “dope”).

### (Solution Casting)

A preferred embodiment of the optical film according to the present invention can be produced through solution casting as described above. Solution casting includes the steps of preparing a dope through dissolution of a cellulose derivative satisfying the properties defined in the present invention and various additives in an organic solvent by heat; casting the prepared dope onto a belt or drum-shaped metal support; drying the cast dope into a web; separating the web from the metal support; stretching or contracting the separated web; drying the stretched or contracted web; and reeling the dry film.

The dope is cast onto a drum or band, and the solvent is evaporated to form a film. The concentration of the precast dope is preferably adjusted to have a solid content within the range of 18% to 35%. The surface of the drum or band is preferably mirror-finished. The dope is preferably cast onto a drum or band having a surface temperature of 10° C. or lower.

The drying process in solvent casting is described in U.S. Pat. Nos. 2,336,310, 2,367,603, 2,492,078, 2,492,977, 2,492,978, 2,607,704, 2,739,069, and 2,739,070, UK Patent Nos. 640731 and 736892, Japanese Examined Patent Application Publication Nos. 45-4554 and 49-5614, and Japanese Patent Application Laid-Open Nos. 60-176834, 60-203430, and 62-115035. The cast film can be dried on the drum or band through blasting of air or inert gas, e.g., nitrogen.

The prepared cellulose derivative solution (dope) can be cast to form a film of two or more layers. In such a case, the cellulose derivative film is preferably prepared through solvent casting. The dope is cast onto a drum or band and the solvent is evaporated to form a film. The concentration of the precast dope is preferably adjusted such that the solid content is within the range of 5% to 40%. The surface of the drum or band is preferably mirror-finished.

### (Stretching)

The optical film (retarder film) according to the present invention is characterized in that the in-plane retardation Ro₅₅₀ measured at a wavelength of 550 nm is within the range of 120 to 160 nm, as described above, and such an in-plane retardation can be achieved through stretching of an optical film prepared as described above.

Any stretching process may be used in the present invention. Examples of a stretching process include longitudinal stretching of a film between multiple rollers turning at different rates, longitudinal stretching of a web of which the edges are fixed with clips or pins and the distances between the clips or pins is extended in the conveying direction, and transverse stretching through extension of the distance between the clips or pins in the lateral direction. These processes may be used alone or in combination.

That is, the film may be stretched horizontal or vertical to the direction of film formation or may be stretched in both directions. The bidirectional stretching may be performed simultaneously or separately. Stretching with a tenter is preferred because linearly driven clips can achieve smooth stretching with reduced risk of breaking.

In a stretching process, the film is usually stretched in the transverse direction (TD) and contracted in the machine direction (MD). Oblique conveyance of the film during contraction enhances the retardation because the directions of the main chains can be readily aligned. The contraction rate can be determined by the angle of conveyance.

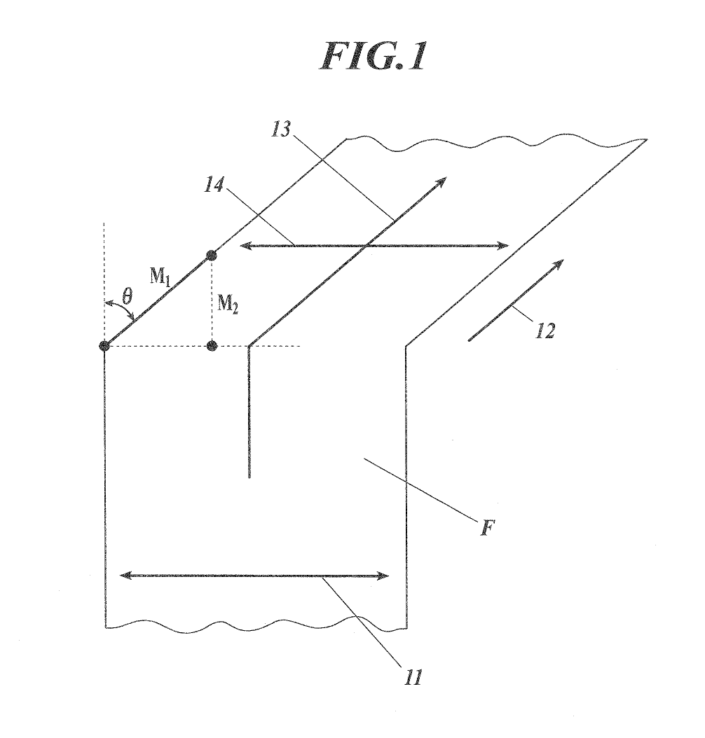

FIG. 1 is a schematic view illustrating the contraction rate in oblique stretching.

With reference to FIG. 1, an optical film F obliquely stretched in a direction denoted by reference numeral 12 is contracted to a length M₂ through oblique bending. That is, if the grippers clamping the optical film F continue to move forward without turning at an angle θ, the grippers should move forward by a distance M₁′ in a predetermined time. Actually, the grippers turn at an angle θ and move forward by a distance M₁ (where M₁=M₁′). At this time, the grippers move by a distance M₂ in the film entering direction (the direction orthogonal to the transverse direction (TD)), and thus, the optical film F is contracted by a length M₃ (where M₃=M₁−M₂).

The contraction rate (%) is defined as:

Contraction Rate(%)=(M₁−M₂)/M₁×100

M₂=M₁×sin(90−θ),

where θ represents the bending angle. Thus, the contraction rate is defined as:

Contraction Rate(%)=(1−sin(90−θ))×100

With reference to FIG. 1, the transverse direction (TD) is denoted by reference numeral 11, the machine direction (MD) is denoted by reference numeral 13, and the slow axis is denoted by reference numeral 14.

In consideration of productivity of a long circularly polarizing plate, the optical film (retarder film) according to the present invention preferably has an orientation angle of 45°±2° from the conveying direction to achieve roll-to-roll bonding with the polarizing film.

### (Stretching by Oblique Stretching Machine)

A procedure of oblique stretching in a 45° angle will now be described. An oblique stretching machine is preferably used in a method of producing an optical film according to the present invention to provide an oblique orientation to the stretched optical film.

An oblique stretching machine suitable for the present invention is preferably a film stretching machine that can vary rail patterns to establish any desired orientation angle in a film and align with high precision the orientation axis of the film across the transverse direction of the film equally to the right and left, and control the thickness and the retardation of the film with high precision.

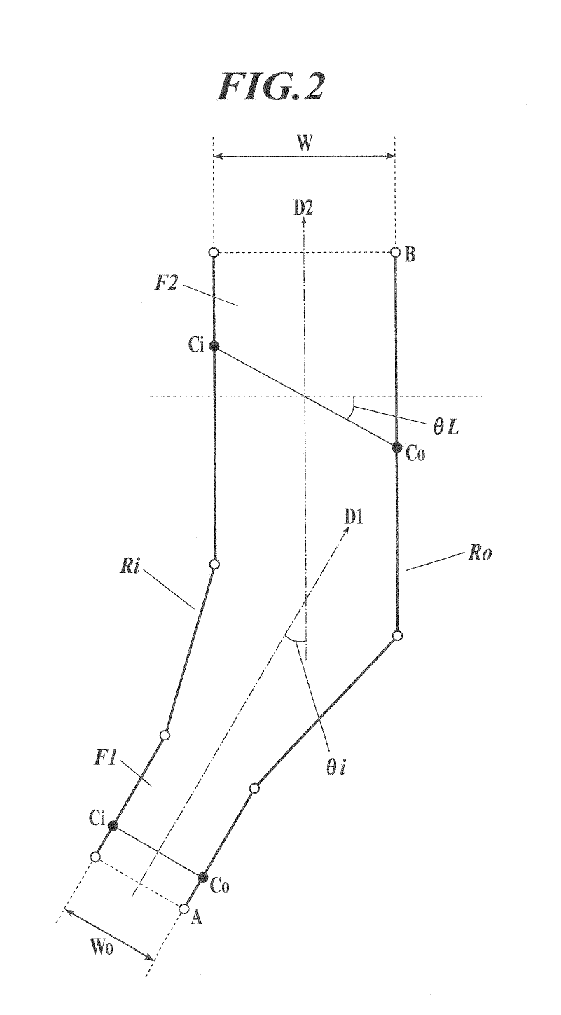

FIG. 2 illustrates an example rail pattern of an oblique stretching machine that is suitable for the production of an optical film according to the present invention. FIG. 2 illustrates a mere example, and any other oblique stretching machine may also be used in the present invention.

In an oblique stretching machine illustrated in FIG. 2, the feeding direction D1 of a long film roll F1 usually intersects the reeling direction D2 of the stretched film F2 at a feeding angle θi. The feeding angle θi may be any angle more than 0° and less than 90°. In the present invention, the term “long” refers to a length that is at least five times the film width, preferably 10 times or more.

The edges of the long film roll F1 are supported by left and right grippers Ci and Co (tenters) at the inlet of the oblique stretching machine (position A in FIG. 2). As the grippers Ci and Co move, the film roll F1 also moves. The left and right grippers Ci and Co, which face each other in a direction substantially orthogonal to the forward direction (feeding direction D1) of the film at the inlet of the oblique stretching machine (position A in FIG. 2), move along asymmetric rails Ri and Ro, and release the film held by the tenters at the position where stretching is completed (position B in FIG. 2).

The left and right grippers facing each other at the inlet of the oblique stretching machine (position A in the drawing) move on the asymmetric rails Ri and Ro, and eventually the gripper Ci moving on the Ri moves ahead of the gripper Co moving on the Ro.

That is, the grippers Ci and Co, which are facing each other in a direction substantially orthogonal to the feeding direction D1 of the film at the inlet A of the oblique stretching machine (where the grippers first clamps the film), change their relative positions such that the straight line between the grippers Ci and Co tilt by an angle θL from the direction substantially orthogonal to the reeling direction D2 of the film at position B where the stretching of the film is completed.

The film roll is obliquely stretched through the procedure described above. The term “substantially orthogonal” refers to an angle of 90°±1°.

More specifically, a method of producing an optical film according to the present invention should include a step of oblique stretching using tenters that can perform oblique stretching as described above.

The stretching machine heats a film roll F1 to a predetermined stretching temperature and obliquely stretches the film. The stretching machine includes a heating zone, left and right rails on which grippers move to convey the film, and multiple grippers that move on the rails. Both edges of the film fed into the inlet of the stretching machine are clamped by the grippers; the film is guided through the heating zone; and the film is released from the grippers at the outlet of the stretching machine. The film released from the grippers is wound around a core. The rails follow endless and continuous paths. Thus the grippers that have released the film at the outlet of the stretching machine move along the exterior and continuously returns to the inlet.

The rail pattern of the stretching machine is asymmetric. The rail pattern can be manually or automatically controlled depending on the orientation angle and stretching rate of the long stretchable film to be produced. The oblique stretching machine according to the present invention preferably includes rails and freely adjustable rail joins, which can be arranged in a desired rail pattern (marks “◯” in FIG. 2 indicate example joints).

The grippers of the stretching machine in the present invention move at a constant rate while maintaining regular intervals with the preceding and succeeding grippers. The moving rate of the grippers can be appropriately selected. A typical rate is 1 to 100 m/min. The difference in moving rates of the left and right grippers is typically 1% or less of the moving rates, preferably 0.5% or less, more preferably 0.1% or less. That is, a difference in the moving rates of the left and right edges of the film at the stretching outlet readily causes wrinkles or biases in the film at the stretching outlet. Thus, the moving rates of the left and right grippers should be substantially identical. In a typical stretching machine, the moving rate fluctuates on an order of seconds or less due to factors such as the pitch of the teeth on a sprocket driving the chain and the frequency of the driving motor. Such fluctuation often reaches several percent of the moving rates but does not apply to the difference in moving rates concerned in the present invention.

The rails of the stretching machine suitable for the present invention control the trajectories of the grippers and often bend at an acute angle particularly in regions where the film is conveyed obliquely. The grippers should move along a curve in such regions so as to avoid interference of grippers due to an acute bending angle or local concentration of stress.

According to the present invention, both edges of the long-film roll F1 are clamped by a sequence of left and right grippers at the inlet of the oblique stretching machine (position A in FIG. 2) and are moved forward as the grippers move. The left and right grippers facing each other in a direction substantially orthogonal to the forward direction (feeding direction D1) of the film at the inlet of the stretching machine (position A in FIG. 2) move through the heating zone including a preheating subzone, a stretching subzone, and a thermal fixing subzone on the asymmetric rails.

In the preheating subzone, the grippers clamping both edges of the film at the inlet of the heating zone move forward while maintaining regular intervals.

In the stretching subzone, the intervals of the grippers clamping both edges of the film increase to a predetermined length. In the stretching subzone, the film is obliquely stretched as described above. If required, the film may be stretched vertically or horizontally before the oblique stretching. In oblique stretching, as the film turns, it contracts in the direction in the MD direction (the fast axis direction), which is a direction orthogonal to the slow axis.

Contraction of the optical film according to the present invention in a direction orthogonal to the stretching direction (fast axis direction) after stretching rotates, for example, the orientation of optical controllers (e.g., retardation enhancers and wavelength-dispersion enhancers), which is misaligned from the main chains of the cellulose derivative, which is matrix resin, so as to align the main axes of the optical controllers with the main chains of the cellulose derivative. As a result, the refractive index n_{y280} along the fast axis at 280 nm in the ultraviolet range can significantly increase and the tilt of the n_{y} normal wavelength dispersion in the visible light range becomes steep.

In the thermal fixing subzone, the distance of the grippers clamping both edges of the film is fixed downstream of the stretching subzone, and the grippers move in parallel with each other. After passing through the thermal fixing subzone, the film may pass through an additional subzone (cooling subzone) having a temperature lower than or equal to the glass transition temperature Tg of the thermoplastic resin of the film. The rails may be arranged in a pattern that reduces the distance between opposing grippers, in consideration of the contraction caused by cooling of the film.

The temperatures of the subzones are preferably set within the following ranges, where Tg is the glass transition temperature of the thermoplastic resin: Tg to Tg+30° C. in the preheating subzone; Tg to Tg+30° C. in the stretching subzone; and Tg−30° C. to Tg in the cooling subzone.

The temperature in the stretching subzone may vary so as to reduce unevenness in the thickness of the film across the width direction. The temperature in the width direction can be varied in the stretching subzone through known processes, such as varying the degree of opening of the nozzles feeding hot air into a temperature-controlled chamber along the width direction or varying the heat from heaters aligned in the width direction.

The lengths can be appropriately selected for the preheating subzone, the stretching subzone, the contraction subzone, and the cooling subzone. The length of the preheating subzone is typically within the range of 100% to 150% of that of the stretching subzone, and the length of the thermal fixing subzone is typically within the range of 50% to 100% of that of the stretching subzone.

The stretching rate (W/Wo) in the stretching process is preferably within the range of 1.3 to 3.0, more preferably 1.5 to 2.8. A stretching rate within such a range can reduce the unevenness in the thickness across the width. Varying the stretching temperature along the width direction in the stretching subzone of the oblique stretching machine can reduce the unevenness in the thickness along the width direction. Wo represents the width of the film before stretching, and W represents the width of the film after stretching.

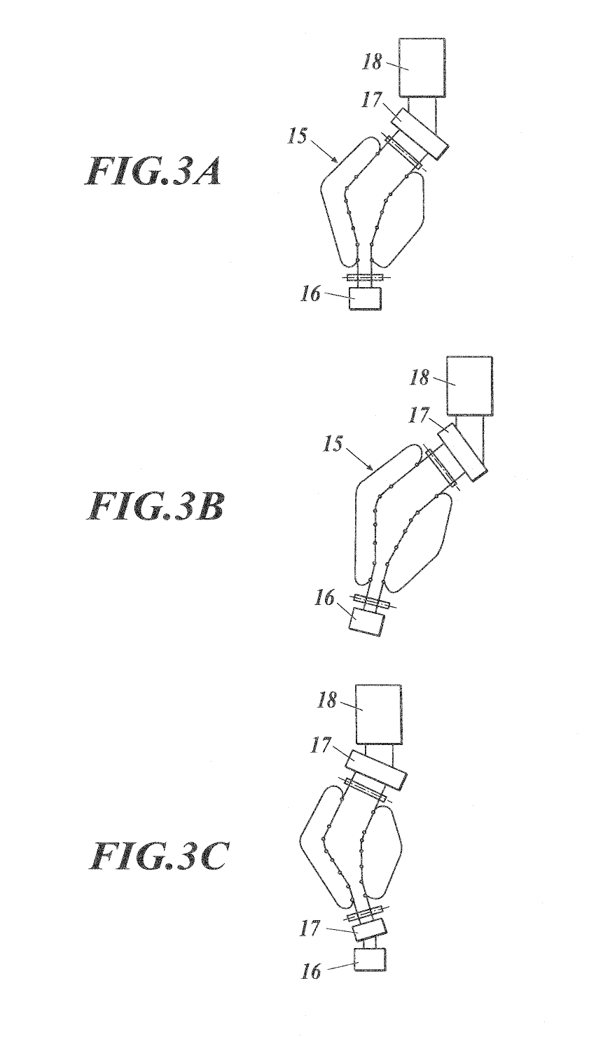

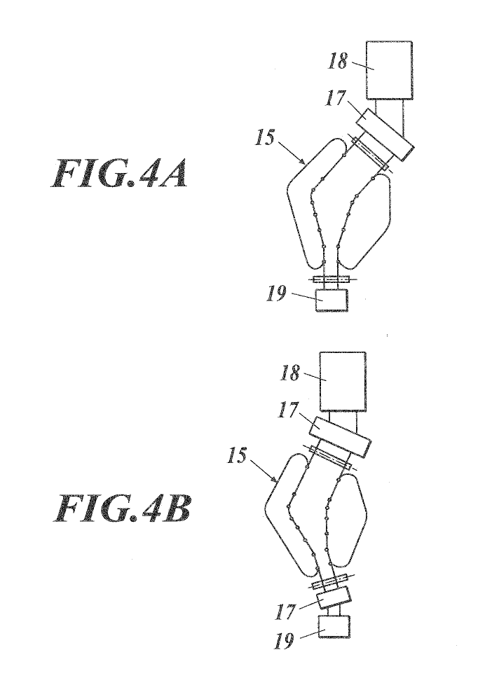

Examples of oblique stretching processes suitable for the present invention include, in addition to that illustrated in FIG. 2, those illustrated in FIGS. 3A to 3C and FIGS. 4A and 4B.

FIGS. 3A to 3C illustrate example methods of producing an optical film (example methods of feeding a film from a long-film roll and obliquely stretching the film) according to the present invention, and illustrate arrangement patterns for reeling the film into a long-film roll and then feeding the film for oblique stretching. FIGS. 4A and 4B illustrate example methods of producing an optical film (example methods of obliquely stretching a film without reeling the film from a roll) according to the present invention, and illustrate arrangement patterns for continuously stretching the film obliquely without reeling the film from the roll.

In FIGS. 3A to 3C and FIGS. 4A and 4B, reference numeral 15 represents an oblique stretching machine, reference numeral 16 represents a film feeder, reference numeral 17 represents a conveying-direction changer, reference numeral 18 represents a winder, and reference numeral 19 represents a film former. Drawings of the same components may be provided without redundant reference numerals.

The film feeder 16 is preferably slidable and pivotable at a predetermined angle to the inlet of the oblique stretching machine 15 to feed a film to the inlet of the oblique stretching machine 15 or is preferably slidable and feeds a film to the inlet of the oblique stretching machine 15 through the conveying-direction changer 17. FIGS. 3A to 3C illustrate different arrangement patterns with the film feeder 16 and the conveying-direction changer 17 disposed at different positions. FIGS. 4A and 4B illustrate arrangement patterns for direct feeding of the film deposited by the film former 19 to the stretching machine 15. The film feeder 16 and the conveying-direction changer 17 positioned in this way reduces the width of the entire apparatus and enables precise control of the feeding position and angle of the film. This can provide a long stretched film having low variations in thickness and optical parameters. The film feeder 16 and conveying-direction changer 17 effectively prevent insufficient gripping of the film by the left and right clips.

The winder 18 is disposed at a predetermined angle to the outlet of the oblique stretching machine 15 for reeling of the film. In this way, the reeling position and angle of the film can be precisely controlled so as to acquire a long stretched film having low variations in the thickness and optical parameters. Thus, wrinkles in the film can be surely prevented, and the reeling efficiency of the film can be enhanced. Thus, a long film can be reeled. According to the present invention, the reeling tension T (N/m) of the stretched film is controlled within the range of 100<T<300 N/m, preferably 150<T<250 N/m.

### (Melt Film Formation Method)

The optical film (retarder film) according to the present invention can be prepared through melt film formation method, other than solution casting method described above. In the melt film formation method, a composition containing a cellulose derivative and additives, such as a plasticizer, is heated to a predetermined temperature at which the composition melts into a fluid. The melt containing fluid thermoplastic resin is cast to form a film.

Melt film formation method can be categorized into different methods of, for example, melt extrusion molding, press molding, inflation molding, injection molding, blow molding, and stretch molding. Among these methods, melt extrusion molding is preferred in view of superior mechanical strength and surface precision.

Normally, it is preferred to perform preliminary kneading and pelletization of several raw materials used in extrusion molding. Pellets can be prepared through known procedures. For example, a dry cellulose derivative, a plasticizer, and other additives can be fed to an extruder through a feeder, kneaded in a single or double shaft extruder, extruded in the form of strands from a die, cooled by water or air, and cut into pellets.

The additives may be mixed before feeding to the extruder or supplied through individual feeders. Preliminary mixing is preferred for small amounts of additives, such as particles of matting agents and antioxidants, to yield a homogeneous mixture.

The extruder used for pelletization should process the material at a low temperature to reduce shear force and degradation (reduction in molecular weight, colorization, and gel formation) in the resin. For example, a preferred double-shaft extruder has deep-groove screws that rotate in the same direction. Engaged screws are preferred for uniform kneading.

The resulting pellets are used to form a film. Alternatively, non-pelletized, powdered raw materials can be supplied to the extruder through a feeder, heated and melted, and used to form a film.

The pellets in a single or double shaft extruder are melted at a temperature within the range of 200° C. to 300° C. and extruded, fed through a leaf disc filter for removal of foreign material, and cast from a T die into a film. The resulting film is nipped between a cooling roller and an elastic touch roller to solidify the film on the cooling roller.

The pellets should be fed from a feed hopper to the extruder under a vacuum, reduced pressure, or inert gas atmosphere for prevention of oxidative decomposition.

The extrusion rate should be stabilized through the use of a gear pump, for example. The filter used to remove foreign materials is preferably a sintered stainless steel fiber filter. The sintered stainless steel fiber filter is prepared through compression and sintering of intertwined stainless steel fibers into a single product. The thickness of the fiber and the degree of compression are varied to vary the density, thereby controlling the degree of filtration.

Additives such as plasticizers and particles may be preliminarily mixed with the resin or may be mixed with the resin in the extruder. A static mixer, for example, should be used for uniform mixing.

The temperature of the surface of the film adjacent to the elastic touch roller that is nipped between the cooling roller and the elastic touch roller is preferably within the range of Tg to Tg+110° C. Any known elastic touch roller having an elastic surface may be used for this purpose. A commercially available elastic touch roller, which is also referred to as a clamping rotator, may also be used.

When separating the film from the cooling roller, the tension is preferably controlled so as to prevent deformation of the film.

The resulting film can be stretched and contracted through a stretching operation performed after passing through the cooling roller. A known roller stretching machine or an oblique stretching machine used for the solution casting described above may be preferably used for stretching and contracting of the film. The stretching temperature is preferably within the range of Tg to Tg+60° C. of a typical resin in the film.

Prior to reeling of the film, the edge portions of the film may be trimmed to a predetermined width conforming to product specification. The trimmed edges may be knurled (embossed) to prevent adhesion and scratching of the film during reeling. The film is knurled with a metal ring having an embossed pattern on the side face through heating and pressing. The edge portions of the film clamped with clips, which are usually deformed and unsuitable for products, are cut off. The cutoffs are reused in the film formation processes described above.

Retarder films according to the present invention are laminated such that the angle between the slow axis and the transmission or absorption axis of the polarizer element descried below intersect at substantially 45°, to produce a circularly polarizing plate. In the present invention, the term “substantially 45°” refers to an angle within the range of 40° to 50°.

The in-plane slow axis of the retarder film according to the present invention intersects the transmission or absorption axis of the polarizer element at an angle preferably within the range of 41° to 49°, more preferably 42° to 48°, more preferably 43° to 47°, most preferably 44° to 46°.

### <<Circularly Polarizing Plate>>

The circularly polarizing plate according to the present invention should be produced through the cutting of a long roll of a laminate of a long protective film, a long polarizer element, and a long retarder film according to the present invention, stacked in this order. The circularly polarizing plate according to the present invention, which is composed of the retarder film according to the present invention, is included in an organic EL display device, which is described below, so as to block mirror reflection of metal electrodes in the organic EL elements in all wavelengths in the visible light range. This can prevent the reflection during viewing and enhance black display.

The circularly polarizing plate according to the present invention should have UV absorptive capacity. A protective film having UV absorptive capacity on the viewing side is preferred for the protection of both polarizer elements and organic EL elements from ultraviolet rays. A retarder film having UV absorptive capacity disposed on the light-emitting side (for example, the side adjacent to the organic EL elements) can reduce degradation of the organic EL elements in the organic EL display device described below.

The circularly polarizing plate according to the present invention includes a retarder film according to the present invention having a slow axis tilted from the longitudinal direction by an angle (i.e., orientation angle θ) of “substantially 45°.” In this way, formation of an adhesive layer and bonding of the polarizer element and the retarder film can be carried out in a continuous production line. Specifically, a step of bonding the polarizer element and the retarder film can be incorporated into or after the step of drying, which is carried out subsequent to the step of producing the polarizer element through stretching of a polarizing film, to sequentially supply the polarizer element and the retarder film. The bonded polarizer element and retarder film can be reeled into a roll. In this way, the process can proceed to the subsequent step in a continuous online production line. During the bonding of the polarizer element and the retarder film, a protective film can also be fed from a roll and continuously bonded to the polarizer element and the retarder film. The retarder film and the protective film are preferably simultaneously bonded to the polarizer element, in view of high performance and productivity. That is, the protective film and the retarder film can be bonded to the opposite sides of the polarizer element during or after drying performed subsequent to the production of the polarizer element through stretching of a polarizing film, to produce a roll of circularly polarizing plate.

In the circularly polarizing plate according to the present invention, the polarizer element is preferably disposed between the retarder film according to the present invention and the protective film, and a cured layer is preferably laminated to the viewing side of the protective film.

The present invention is characterized in that the circularly polarizing plate according to the present invention is provided in an organic electroluminescent display device. The circularly polarizing plate according to the present invention in an organic electroluminescent display device prevents mirror reflection of metal electrodes of organic electroluminescent emitting bodies.

### (Protective Film)

In a circularly polarizing plate according to the present invention, a polarizer element is preferably disposed between an optical film (retarder film) and a protective film. A film containing cellulose ester is suitable as a protective film for such a circularly polarizing plate. Preferred cellulose ester films are commercially available (for example, Konica Minolta TAC films KC8UX, KC5UX, KC4UX, KC8UCR3, KC4SR, KC4BR, KC4CR, KC4DR, KC4FR, KC4KR, KC8UY, KC6UY, KC4UY, KC4UE, KC8UE, KC8UY-HA, KC2UA, KC4UA, KC6UAKC, 2UAH, KC4UAH, and KC6UAH (which are products of Konica Minolta, Inc.), and Fuji TAC films T40UZ, T60UZ, T80UZ, TD80UL, TD60UL, TD40UL, R02, and R06 (which are product of Fujifilm Holdings Corporation)). The protective film may have any thickness. A typical thickness of a protective film is within the range of approximately 10 to 200 μm, preferably 10 to 100 μm, more preferably 10 to 70 μm.

### (Polarizer Element)

A polarizer element transmits light polarized in a specific direction. An example of such a polarizer element includes polyvinyl alcohol polarizing films. Polyvinyl alcohol polarizing films are composed of polyvinyl alcohol films dyed with iodine or dichroic dyes.

To compose a polarizer element, a polyvinyl alcohol film is dyed after uniaxial stretching or uniaxially stretched after dying. The resulting film is preferably treated with a boron compound to enhance durability. The polarizer element preferably has a thickness within the range of 5 to 30 μm, more preferably 5 to 15 μm.

Preferred examples of polyvinyl alcohol films include the ethylene modified polyvinyl alcohol films disclosed in Japanese Patent Application Laid-Open Nos. 2003-248123 and 2003-342322, which have an ethylene unit content of 1 to 4 mol %, a degree of polymerization of 2000 to 4000, and a degree of saponification of 99.0 to 99.99 mol %. A polarizer element, which is prepared in accordance with any of the procedures described in Japanese Patent Application Laid-Open No. 2011-100161 and Japanese Patent Publication Nos. 4691205 and 4804589, should be bonded to an optical film according to the present invention to produce a polarizer.

### (Adhesive)

Any bonding scheme may be used to bond the optical film and the polarizer element according to the present invention. An example bonding scheme involves bonding of a saponified optical film according to the present invention with a completely saponified polyvinyl alcohol adhesive. Although an active-beam curable adhesive is acceptable, a light curable adhesive is preferred for the high elasticity of the resulting adhesive layer and a small degree of deformation in the polarizer.

A preferred example of a light curable adhesive is disclosed in Japanese Patent Application Laid-Open No. 2011-028234, which has a composition containing the following components: (α) a cationically polymerizable compound; (β) a photocationic polymerization initiator; (γ) a photosensitizer having a maximum absorption wavelength of 380 nm or larger; and (δ) a naphthalene photosensitizer. Alternatively, other light curable adhesives may be used.

An example method of producing a polarizer with a light curable adhesive will now be described. A polarizer can be produced through a method including:

(1) preprocessing step of treating a surface of a polarizer element of an optical film to enhance adhesiveness;

(2) an adhesive applying step of applying the light curable adhesive to at least one of adhesive surfaces of the polarizer element and the optical film;

(3) a bonding step of bonding the polarizer element and the optical film with an adhesive layer; and

(4) a curing step of curing the adhesive layer disposed between the bonded polarizer element and optical film. The preprocessing step (1) is optional.

### <Preprocessing Step>

In the preprocessing step, the surface of the optical film adjacent to the polarizer element is treated to enhance its adhesiveness. If optical films are bonded to both sides of the polarizer element, the surfaces of the optical films adjacent to the polarizer element should be treated to enhance their adhesiveness. Examples of adhesiveness enhancement treatment include corona treatment and plasma treatment.

### <Adhesive Applying Step>

In the adhesive applying step, the light curable adhesive is applied to at least one of the bonding surfaces of the polarizer element and optical film. The light curable adhesive can be directly applied to the surface of the polarizer element and/or optical film through any application procedure. For example, various application tool may be employed, such as a doctor blade, a wire bar, a die coater, a comma coater, or a gravure coater. Alternatively, the light curable adhesive may be cast between the polarizer element and the optical film, and the adhesive may be uniformly spread through pressing with rollers.

### <Bonding Step>

After the light curable adhesive is applied, the layers are to be bonded. In the bonding step, if the light curable adhesive is applied to the surface of the polarizer element in the previous applying step, the optical film is disposed over the adhesive. If the light curable adhesive is applied to a surface of the optical film in the applying step, the polarizer element is disposed over the adhesive. Alternatively, if the light curable adhesive is cast between the polarizer element and the optical film, the polarizer element and the optical film are layered on each other in their states. If optical films are bonded to both sides of a polarizer element with a light curable adhesive, the optical films are disposed onto both sides of the polarizer element with the applied light curable adhesive therebetween. Usually, the laminate of layers are pressed with rollers from both sides (i.e., the rollers press on the polarizer element and the optical film if the laminate contains an optical film bonded to a single side of a polarizer element, or the rollers press on the optical films if optical films are bonded to both sides of the polarizer element). Materials suitable for the rollers include metal and rubber. The opposing rollers may be composed of the same material or different materials.

### <Curing Step>

In the curing step, the uncured light curable adhesive is irradiated with active energy beams to form a cured adhesive layer containing epoxy compounds and/or oxetane compounds. This process bonds the polarizer element and the optical film with the light curable adhesive. If an optical film is bonded to a single side of the polarizer element, the active energy beams may be radiated onto either the polarizer element or the optical film. Alternatively, if optical films are bonded to both sides of the polarizer element, one of the optical films bonded to both sides of the polarizer element with the light curable adhesive should be irradiated with active energy beams so as to simultaneously cure the layers of light curable adhesive applied on both sides.

Examples of active energy beams include visible light beams, ultraviolet light beams, X-rays, and electron beams. Electron beams and ultraviolet light beams are usually preferred for ready handling and sufficient curing rates.

Any condition on electron beam irradiation may be employed for the curing of the adhesive. For example, an electron beam is irradiated with an acceleration voltage preferably in the range of 5 to 300 kV, more preferably 10 to 250 kV. Electron beams having an acceleration voltage of 5 kV or more reaches the adhesive and achieves a desire degree of curing, whereas electron beams having an acceleration voltage of 300 kV or less has an optimal penetration and penetrates the transparent optical film and polarizer element without causing their damage. Typical dose is within the range of 5 to 100 kGy, preferably 10 to 75 kGy. A dose of 5 kGy or more achieves sufficient curing of the adhesive, whereas a dose of 100 kGy or less does not damage the transparent optical film and polarizer element. This prevents a reduction in mechanical strength and yellowing, achieving desired optical characteristics.

If the active energy beams are ultraviolet rays, any condition on the ultraviolet irradiation may be employed for the curing of the adhesive. The cumulative dose of the ultraviolet irradiation is preferably within the range of 50 to 1500 mJ/cm², more preferably 100 to 500 mJ/cm².

In a polarizer prepared as described above, the adhesive may be provided at any thickness. A typical thickness is within the range of 0.01 to 10 μm, preferably 0.5 to 5.0 μm.

### <<Organic EL Display Device>>

The organic EL display device according to the present invention includes a circularly polarizing plate according to the present invention, which is produced through the processes described in detail above.

Specifically, the organic EL display device according to the present invention includes a circularly polarizing plate composed of an optical film (retarder film) according to the present invention and an organic EL element. Thus, the organic EL display device can prevent reflection of external light during viewing and improve the black display. The screen of the organic EL display device may have any size, for example, 50.8 cm (20 inches) or larger.

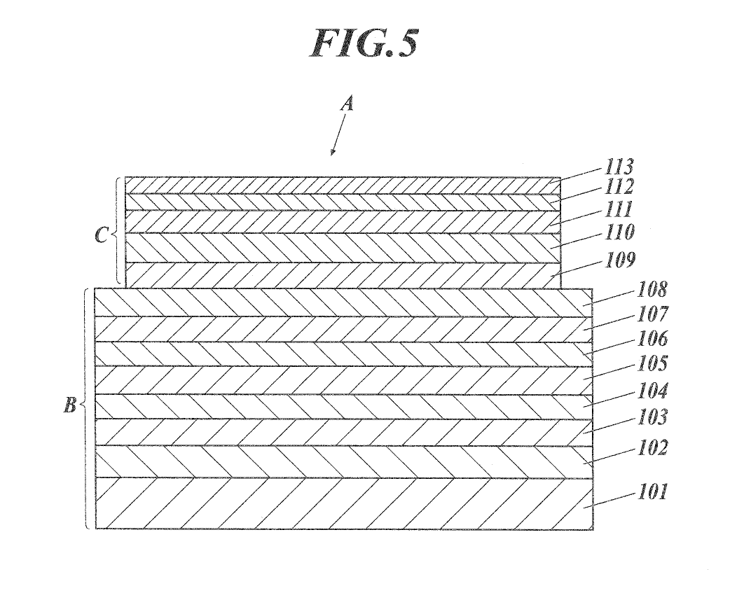

FIG. 5 is a schematic view of an organic EL display device according to the present invention. The configuration of an organic EL display device A according to the present invention should not be limited to that illustrated in FIG. 5.

With reference to FIG. 5, the organic EL display device A includes an organic EL element B and a long circular polarizer C according to the present invention disposed on the organic EL device B; the organic EL device B includes a glass or polyimide transparent substrate 101, a metal electrode 102, a TFT 103, an organic light-emitting layer 104, a transparent electrode (composed of ITO, for example) 105, an insulating layer 106, a sealing layer 107, and a film 108 (optional), disposed in sequence, and the circularly polarizing plate C includes a retarder film 109 according to the present invention, a protective film 111, and a polarizer element 110 disposed therebetween. A cured layer 112 should preferably be disposed on the protective film 111. The cured layer 112 not only prevents the surface of the organic EL display device from scratches but also prevents bending due to the long circularly polarizing plate. An antireflective layer 113 may be disposed on the cured layer 112. The organic EL element B has a thickness of approximately 1 μm.

Typically, the organic EL display device A includes a light-emitting element (organic EL element B), which includes a transparent substrate 101, a metal electrode 102, an organic light-emitting layer 104, and a transparent electrode 105, disposed in sequence. The organic light-emitting layer 104 is a laminate of various thin-film organic functional sublayers. Examples of such laminates include a laminate of a positive-hole injecting sublayer, which is composed of a triphenylamine derivative, and a light-emitting sublayer, which is composed of a fluorescent organic solid, such as anthracene; a laminate of the above-mentioned light-emitting sublayer and an electron injecting sublayer, which is composed of a perylene derivative; a laminate of a positive-hole injecting sublayer, a light-emitting sublayer, and an electron injecting sublayer; and a laminate composed of a combination of the laminates mentioned above.

The principle of light emission in the organic EL display device A involves applying a voltage to the transparent electrode 105 and the metal electrode 102, injecting positive holes and electrons to the organic light-emitting layer 104, exciting phosphors with the energy generated through recombination of the positive holes and the electrons, and radiating light from the phosphors returning to the ground state. A typical diode is also based on the same mechanism of recombination. As presumed from this fact, an electric current and the intensity of emitted light exhibit high non-linearity with rectification against the applied voltage.

At least one of the electrodes in the organic EL display device must be transparent in order to radiate the light generated in the organic light-emitting layer. Thus, the organic EL display device usually includes a transparent electrode composed of a transparent conductor, such as indium tin oxide (ITO), serving as an anode. In contrast, the cathode should be composed of a substance having a small work function so as to facilitate electron injection and enhance the light-emitting efficiency. Thus, the organic EL display device usually includes a metal electrode composed of Mg—Ag or Al—Li, for example.

The circularly polarizing plate including the retarder film according to the present invention can be suitably used for a large-screen organic EL display device having a screen size of 20 inches or more, which is equivalent to a diagonal screen length of 50.8 cm or more.

The organic light-emitting layer in the organic EL display device having such a configuration has a thickness of approximately 10 nm, which is significantly thin. Thus, the organic light-emitting layer is substantially transparent to light, like a transparent electrode. As a result, external light enters the surface of the transparent substrate in a non-light emitting mode, pass through the transparent electrode and the organic light-emitting layer, is reflected at the metal electrode, and returns to the surface of the transparent substrate. Thus, the screen of the organic EL display device appears as a mirror surface when viewed from outside.

An organic EL display device includes an organic EL element having a transparent electrode emitting light in response to application of a voltage on the front surface of an organic light-emitting layer and a metal electrode on the back surface of the organic light-emitting layer, and may further include a polarizer disposed on the front surface (viewed surface) of the transparent electrode and a retarder disposed between the transparent electrode and the polarizer.

The retarder film and the polarizer polarize incident external light reflected at the metal electrode. Thus, the polarizing effect causes the mirror surface of the metal electrode to appear externally invisible. Specifically, the retarder film is composed of a λ/4 retarder film, and the angle between the polarizing direction of the polarizer element and the polarizing direction of the retarder film is adjusted to 45° or 135°, so as to completely block light from the mirror surface of the metal electrode.

That is, only the linearly polarized component of the external light is incident on the organic EL display device through the polarizer element. This linearly polarized light is usually elliptically-polarized by the retarder but is circularly polarized if the retarder film is a λ/4 retarder film and the angle between the polarizing direction of the polarizer element and the polarizing direction of the retarder film to 45° or 135°.

The circularly polarized light transmits the transparent substrate, the transparent electrode, and the organic thin-film, is reflected at the metal electrode, transmits the organic thin-film, the transparent electrode, and the transparent substrate, and is linearly polarized at the retarder film. The linearly polarized light cannot transmit the polarizer because the direction of polarization is orthogonal to the polarizer. As a result, the light from the mirror surface of the metal electrode is completely blocked.

### EXAMPLES

Examples of the present invention will now be described in detail. The present invention should not be limited by these examples. The sign “%” in the examples refers to “mass %,” unless otherwise specified. The degree of substitution and the number of substituents are averaged.

### Example 1

### Synthesis of Cellulose Derivative

### [Synthesis of Cellulose Derivative A-1]

### (First Step: Synthesis of Cellulose Ether 1)

A 60% sodium hydroxide solution (140 g) was added to and mixed with hardwood prehydrolysis kraft pulp containing 98.4% α-cellulose (100 g). Bromobutane (400 g) was added, and the mixture was stirred for approximately one hour while the temperature was maintained in the range of 0° C. to 5° C. The mixture was then kept at a temperature within the range 30° C. to 40° C. for six hours for reaction. The content of the mixture was filtered to remove the precipitation. Hot water was added to the filtered solution. After neutralization with a 1% phosphoric acid solution, the neutralized solution was added dropwise to acetone to precipitate the reaction product. The reaction product was separated through filtration, washed several times with a 9:1 (volume ratio) solvent of acetone and water, and dried under vacuum at 60° C., to yield butylcellulose. The degree of substitution (MS) of bromobutane in the product was determined to be 1.1 through NMR spectroscopy. The product was referred to as cellulose ether A.

### (Second Step: Introduction of Substituents Having Multiple Bonds and Acetyl Groups to Cellulose Ether A)

A 3-L three-neck flask with a mechanical stirrer, a thermometer, a condenser tube, and a dropping funnel was charged with cellulose ether A (200 g) prepared in the first step, pyridine (90 mL), and acetone (2000 mL), which were then stirred at room temperature. Acetyl chloride (350 g) was slowly added dropwise to the mixture, which was then stirred for 8 hours at 50° C. After the reaction, the reactant was cooled to room temperature and then was added to methanol (20 L) while the system was vigorously agitated, to precipitate a white solid. The white solid was suction filtered and rinsed three times with large volumes of methanol. The resulting white solid was dried for one day at 60° C. and dried under vacuum for six hours at 90° C., to obtain cellulose derivative A-1.

The average degree of substitution of the substituents in glucose skeletons of cellulose derivative A-1 prepared as described above was determined by ¹H-NMR or ¹³C-NMR spectroscopic procedures described in “Cellulose Communication 6, 73-79 (1999)” and “Chirality 12(9), 670-674.” The number of butoxy substituents having ether bonds in cellulose derivative A-1 was 1.1, the number of benzoate substituents having multiple bonds was 0.6, and the number of acetyl substituents was 1.3; which led to a total degree of substitution of 3.0.

### [Synthesis of Cellulose Derivatives A-2 to A-6]

The ratio of the components and the reaction conditions in the first and second steps of the synthesis of cellulose derivative A-1 were appropriately varied to synthesize cellulose derivatives A-2 to A-6 having the substituents in glucose skeletons listed in Table 1.

### [Synthesis of Cellulose Derivative A-7]

### (First Step)

A 3-L three-neck flask with a mechanical stirrer, a thermometer, a condenser tube, and a dropping funnel was charged with Cellulose acetate (250 g) having a degree of acetyl substitution of 2.15, pyridine (114 mL), and acetone (3000 mL), which were then stirred at room temperature. Benzoyl chloride (160 g) was slowly added dropwise to the mixture, which was then stirred for eight hours at 50° C. After the reaction, the reactant was cooled to room temperature and then was added to methanol (20 L) while the system was vigorously agitated, to precipitate a white solid. The white solid was suction filtered and rinsed three times with large volumes of methanol. The resulting white solid was dried for one day at 60° C. and dried under vacuum for six hours at 90° C., to obtain an intermediate.

### (Second Step)

A 3-L three-neck flask with a mechanical stirrer, a thermometer, a condenser tube, and a dropping funnel was charged with the intermediate (40 g) prepared in the first step, pyridine (400 mL) and acetone (100 mL), which were then stirred at room temperature. To the system, 2,4,6-trimethoxybenzoyl chloride (20.5 g) was slowly added dropwise to the mixture, which was then stirred for eight hours at 50° C. After the reaction, the reactant was cooled to room temperature and then was added to methanol (10 L) while the system was vigorously agitated, to precipitate a white solid. The white solid was suction filtered and rinsed three times with large volumes of methanol. The resulting white solid was dried for one day at 60° C. and dried under vacuum for six hours at 90° C., to obtain cellulose derivative A-7.

The average degree of substitution of the substituents in glucose skeletons of cellulose derivative A-7 prepared as described above was determined by ¹H-NMR or ¹³C-NMR spectroscopic procedures described in “Cellulose Communication 6, 73-79 (1999)” and “Chirality 12(9), 670-674.” The number of benzoate substituents having multiple bonds was 0.33, the number of 2,4,5-trimethoxybenzoate substituents having multiple bonds was 0.08, and the number of acetyl substituents was 2.15; which led to a total degree of substitution of 2.56. Cellulose derivative A-7 contained none of the substituents having ether bonds.

### [Synthesis of Cellulose Derivative A-8]

Cellulose derivative A-8 was synthesized as in cellulose derivative A-7 except that the following first step was employed.

### (First Step)

A 3-L three-neck flask with a mechanical stirrer, a thermometer, a condenser tube, and a dropping funnel was charged with methyl cellulose having a degree of methoxy substitution of 1.8 (40 g), methylene chloride (500 mL), and pyridine (500 mL), which were then stirred at room temperature. Benzyl chloride (160 g) was slowly added dropwise to the mixture, and dimethylaminopyridine (DMAP) (approximately 0.1 g) was added. The mixture was then refluxed for three hours. After the reaction, the reactant was cooled to room temperature. While the reactant was being cooled in ice, methanol (100 mL) was added to quench the reactant. The quenched reactant was added to a mixture of methanol (5 L) and water (5 L) while the solution was vigorously agitated, to precipitate a solid. The solid was suction filtered and rinsed three times with large volumes of water. The resulting white solid was dried under vacuum for six hours at 100° C. to obtain an intermediate.

The average degree of substitution of the substituents in glucose skeletons of cellulose derivative A-8 prepared as described above was determined by ¹H-NMR or ¹³C-NMR spectroscopy through the procedures described in “Cellulose Communication 6, 73-79 (1999)” and “Chirality 12(9), 670-674.” The number of methoxy substituents having ether bonds was 2.15, the number of benzoate substituents having multiple bonds was 0.33, and the number of 2,4,5-trimethoxybenzoate substituents having multiple bonds was 0.08; which led to a total degree of substitution of 2.56.

### <<Production of Retarder Film>>

### [Production of Retarder Film A1]

### (Preparation of Particle Dispersion)

Particles (Aerosil R812 with a primary particle size of approximately 7 nm (manufactured by Nippon Aerosil Co., Ltd.)) 11 parts by mass

Ethanol 89 parts by mass

The particles and ethanol were mixed by agitation in a dissolver for 50 minutes and dispersed with a Manton-Gaulin disperser (manufactured by Gaulin Inc.), which is an ultrahigh-pressure homogenizer, to prepare a particle dispersion.

### (Preparation of Particle Solution 1)

Dimethyl chloride (50 parts by mass) was placed in a dissolving tank, and the particle dispersion (50 parts by mass) was slowly added to the dimethyl chloride while sufficiently stirring the dimethyl chloride dispersant. The mixture was dispersed in an attritor to yield secondary particles having a predetermined particle size. This was filtered through Fine Met NF, which is a sintered stainless steel fiber filter manufactured by Nippon Seisen Co., Ltd., to prepare particle solution 1.

### (Preparation of Dope)

Dimethyl chloride and ethanol were placed in a pressure dissolving tank at quantities listed below. Cellulose derivative A-1 synthesized as described above and an ester compound were added to the organic solvent in the pressure dissolving tank with stirring. The mixture was heated and stirred until completely dissolved. After addition of particle solution 1, the solution was filtered through Azumi filter paper No. 244 manufactured by Azumi Filter Paper Co., Ltd., to prepared a dope.

<Composition of Dope>

| | |
|---|---|
| Dimethyl chloride | 340 parts by mass |
| Ethanol | 64 parts by mass |
| Cellulose derivative A-1 | 100 parts by mass |
| Ester compound (see below) | 5 parts by mass |
| Particle solution 1 | 2 parts by mass |

### <Preparation of Ester Compound>

Into a 2-L four-neck flask with a thermometer, a stirrer, and an Allihn condenser was placed 1,2-propylene glycol (251 g), phthalic anhydride (278 g), adipic acid (91 g), benzoic acid (610 g), and titanium isopropoxide (0.191 g), serving as an esterification catalyst. The mixture was gradually heated to 230° C. in a nitrogen stream with stirring. The resulting mixture was dehydrogenated and condensed for 15 hours. After the reaction, the unreacted 1,2-propylene glycol was distilled under vacuum at 200° C., to obtain an ester compound. The acid value was 0.10 mgKOH/g, and the number average molecular weight was 450.

(Film Formation) The prepared dope was cast onto a stainless steel belt and then separated from the stainless steel belt to obtain a material film.

The separated material film was unidirectionally stretched in the transverse direction (TD) with a tenter while heated. The conveying tension was adjusted to prevent contraction of the material film in the machine direction (MD).

The material film was conveyed through a drying zone by multiple rollers. The dried film was wound into a film roll.

### (Stretching Step)

The material film was obliquely stretched with the diagonal stretching machine illustrated in FIG. 2 such that the optical slow axis of the film intersects the conveying direction at 45°, to produce a roll of retarder film A1.

The stretching conditions including the thickness, stretching temperature, and stretching rates in the transverse direction (TD) and machine direction (MD) of the material film were appropriately adjusted such that the in-plane retardation Ro₅₅₀ measured at a wavelength of 550 nm was 140 nm, the film thickness was 50 μm, and the ratio Ro₄₅₀/Ro₅₅₀ was 0.81.

### [Production of Retarder Films A2 to A8]

Retarder films A2 to A8 were produced as in retarder film A1, except that cellulose derivatives A-2 to A-8 were used in place of cellulose derivative A-1.

The stretching conditions including the thickness, stretching temperature, and stretching rates in the transverse direction (TD) and machine direction (MD) of the material film were appropriately adjusted such that the in-plane retardation Ro₅₅₀ measured at a wavelength of 550 nm was 140 nm, the film thickness was 50 μm, and Ro₄₅₀/Ro₅₅₀ was the value listed in Table 1.

### <<Production of Circularly Polarizing Plate>>

A polyvinyl alcohol film having a thickness of 120 μm was unidirectionally stretched at a temperature of 110° C. and a stretching rate of 5 times. The stretched film was dipped in a solution containing iodine (0.075 g), potassium iodide (5 g), and water (100 g) for 60 seconds, and then dipped in a solution containing potassium iodide (6 g), boric acid (7.5 g), and water (100 g) at 68° C. The film was washed with water and dried, to obtain a polarizer element.

Each retarder film produced in the process described above was bonded to the polarizer element with an adhesive such that the slow axis of the retarder film intersects the absorption axis of the polarizer element at 45°, and a protective film (Konica Minolta TAC film KC4UY having a thickness of 40 μm manufactured by Konica Minolta, Inc.) was bonded to the back side of the polarizer element with a liquid adhesive, to produce circularly polarizing plates A1 to A8.

### <<Production of Organic EL Cell>>

An organic EL cell having a configuration illustrated in FIG. 8 of Japanese Patent Application Laid-Open No. 2010-20925 was produced from 3-mm thick alkali-free glass having a 50-inch (127-cm) size, in accordance with the procedures shown in an embodiment in Japanese Patent Application Laid-Open No. 2010-20925.

### <<Production of Organic EL Display Device)

An adhesive was applied to a surface of each retarder film of each circularly polarizing plate prepared above and bonded to the viewing side of the corresponding organic EL cell, to produce organic EL display devices A1 to A8.

### <<Evaluation of Organic EL Display Device>>

The organic EL display devices prepared through the process described above were evaluated.

### [Evaluation 1 on Stability Against Humidity: Evaluation of Stability of Black Tone]

A black image was displayed on each organic EL display device having an intensity of 1000 Lx at 5 cm above the outermost surface of the organic EL display device, under a low humidity environment of 23° C. and 20% RH. Subsequently, a black image was displayed under a high humidity environment of 23° C. and 80% RH.

The tone of the black display of each organic EL display device was observed and compared under the two different environments described above by ten test participants from the front (0° to the plane normal) and a 40° degree angle to the plane normal, so as to evaluate the effect of humidity on the black tone in accordance with the ranks described below. The stability of the black tone against humidity is allowable for use if the evaluation is A or higher.

⊚: nine or ten participants recognized no effect of humidity on the displayed black image

◯: seven or eight participants recognized no effect of humidity on the displayed black image

Δ: five or six participants recognized no effect of humidity on the displayed black image

x: four or less participants recognized no effect of humidity on the displayed black image

### [Evaluation 2 on Stability Against Humidity: Evaluation of Stability of Reflectivity (Visibility)]

Organic EL display devices for evaluation were produced as in the organic EL display device described above, except that red, blue, and green lines were drawn with felt pen markers (Magic Inks, registered trademark) to the visible surface of the prepared organic EL cell.

The visibility (reflectivity) of the red, blue, and green felt pen lines on the organic EL display devices having an intensity of 1000 Lx at 5 cm above the outermost surface of the organic EL display device were evaluated under a low humidity environment of 23° C. and 20% RH. Subsequently, the visibility (reflectivity) of the felt pen lines were evaluated under a high humidity environment of 23° C. and 80% RH by ten test participants in accordance with the ranks described below. The stability of the reflectivity against humidity is allowable for use if the evaluation is Δ or higher. The term “reflectivity” refers to reflection of light at an organic EL cell inside the circularly polarizing plate, not reflection at the surface of the circularly polarizing plate.

⊚: nine or ten participants recognized no effect of humidity on the visibility of the felt pen lines

◯: seven or eight participants recognized no effect of humidity on the visibility of the felt pen lines

Δ: five or six participants recognized no effect of humidity on the visibility of the felt pen lines

x: four or less participants recognized no effect of humidity on the visibility of the felt pen lines

The results are listed in Table 1.

TABLE 1

| | | CELLULOSE DERIVATIVE | | | | | |
|---|---|---|---|---|---|---|---|
| ORGANIC | | | SUBSTITUENTS HAVING | | SUBSTITUENTS HAVING | | OTHER |
| EL | | | ETHER BONDS | | MULTIPLE BONDS | | SUBSTITUENTS |
| DISPLAY | | | *1 | *2 | *3 | *4 | NUMBER OF |
| DEVICE | RETARDER | | NUMBER OF | NUMBER OF | NUMBER OF | NUMBER OF | ACETYL |
| No. | FILM No. | No. | SUBSTITUENTS | SUBSTITUENTS | SUBSTITUENTS | SUBSTITUENTS | SUBSTITUENTS |
| A1 | A1 | A-1 | 1.1 | 0 | 0.60 | 0 | 1.30 |
| A2 | A2 | A-2 | 0.8 | 0 | 0.60 | 0 | 1.60 |
| A3 | A3 | A-3 | 1.6 | 0 | 0.60 | 0 | 0.80 |
| A4 | A4 | A-4 | 1.8 | 0 | 0.60 | 0 | 0.60 |
| A5 | A5 | A-5 | 2.0 | 0 | 0.60 | 0 | 0.40 |
| A6 | A6 | A-6 | 2.4 | 0 | 0.60 | 0 | 0 |
| A7 | A7 | A-7 | 0 | 0 | 0.33 | 0.08 | 2.15 |
| A8 | A8 | A-8 | 0 | 2.15 | 0.33 | 0.08 | 0 |

| | | | RESULTS OF EVALUATION | | |
|---|---|---|---|---|---|
| ORGANIC | CELLULOSE | | EVALUATION OF STABILITY | | |
| EL | DERIVATIVE | | AGAINST HUMIDITY | | |
| DISPLAY | TOTAL DEGREE | | STABILITY | | |
| DEVICE | OF | Ro₄₅₀/ | OF BLACK | STABILITY OF | |
| No. | SUBSTITUTION | Ro₅₅₀ | TONE | REFLECTIVITY | REMARKS |
| A1 | 3.00 | 0.81 | Δ | Δ | PRESENT INVENTION |
| A2 | 3.00 | 0.79 | X | X | COMPARATIVE EXAMPLE |
| A3 | 3.00 | 0.83 | Δ | Δ | PRESENT INVENTION |
| A4 | 3.00 | 0.84 | ◯ | ◯ | PRESENT INVENTION |
| A5 | 3.00 | 0.85 | ◯ | ◯ | PRESENT INVENTION |
| A6 | 3.00 | 0.86 | ◯ | ◯ | PRESENT INVENTION |
| A7 | 2.56 | 0.83 | X | X | COMPARATIVE EXAMPLE |
| A8 | 2.56 | 0.90 | ◯ | ◯ | PRESENT INVENTION |

*1: ACETOXYPROPYL ETHER GROUP
*2: METHOXY GROUP
*3: BENZOATE GROUP
*4: 2,4,5-TRIMETHOXYBENZOATE GROUP

The results in Table 1 demonstrate that an organic EL display device according to the present invention including a circularly polarizing plate including a retarder film having a configuration according to the present invention has significantly stable black tone and reflectivity (visibility) compared to those of a comparative example, even under an environment with greatly varying humidity.

That is, the black tone and reflectivity of an organic EL display device that has an optical film comprising a cellulose derivative having an average rate of substitution for substituents having ether bonds within the range of 1.0 to 3.0 per glucose skeleton unit were not readily affected by humidity. In contrast, the black tone and reflectivity of organic EL display device A2 consisting of cellulose derivative A-2, which has a number of substituents having ether bonds less than the requirements defined in the present invention, were significantly dependent on humidity. The black tone and reflectivity of organic EL display device A7 consisting of cellulose derivative A-7 without ether bonds were also significantly dependent on humidity.

### Example 2

### Synthesis of Cellulose Derivative

### [Synthesis of Cellulose Derivative B-1]

### (First Step)

A 3-L three-neck flask with a mechanical stirrer, a thermometer, a condenser tube, and a dropping funnel was charged with methyl cellulose having a degree of methoxy substitution of 1.8 (40 g) (SM-15 manufactured Shinetsu Astech Co. Ltd.), methylene chloride (500 mL), and pyridine (500 mL), which were then stirred at room temperature. Acetic anhydride (500 mL) was slowly added dropwise to the mixture, and then dimethylaminopyridine (DMAP) (approximately 0.1 g) was added. The mixture was then refluxed for three hours. After the reaction, the reactant was cooled to room temperature. While the reactant was being cooled in ice, methanol (100 mL) was added to quench the reactant. The quenched reactant was added to a mixture of methanol (5 L) and water (5 L) while the solution was vigorously agitated, to precipitate a white solid. The white solid was suction filtered and rinsed three times with large volumes of water. The resulting white solid was dried under vacuum for six hours at 100° C. to obtain an intermediate.

The resulting intermediate was adjusted through alkaline hydrolysis to a degree of substitution of acetyl groups of 0.6.

### (Second Step)

A 3-L three-neck flask with a mechanical stirrer, a thermometer, a condenser tube, and a dropping funnel was charged with the intermediate (200 g) prepared in the first step, pyridine (90 mL), and acetone (2000 mL), which were then stirred at room temperature. Benzoyl chloride (30 g) was slowly added dropwise to the mixture. The mixture was then stirred for eight hours at 50° C. After the reaction, the reactant was cooled to room temperature and then was added to methanol (20 L) while the system was vigorously agitated, to precipitate a white solid. The white solid was suction filtered and rinsed three times with large volumes of methanol. The resulting white solid was dried for one day at 60° C. and dried under vacuum for six hours at 90° C., to obtain cellulose derivative B-1.

The average degree of substitution of the substituents in glucose skeletons of cellulose derivative B-1 prepared as described above was determined by ¹H-NMR or ¹³C-NMR spectroscopic procedures described in “Cellulose Communication 6, 73-79 (1999)” and “Chirality 12(9), 670-674.” The number of methoxy substituents having ether bonds was 1.8, the number of benzoate substituents having multiple bonds was 0.05, and the number of acetyl substituents was 0.6; which led to a total degree of substitution of 2.45.

### [Synthesis of Cellulose Derivatives B-2 to B-5]

The ratio of the components, the hydrolysis, and reaction conditions in the first and second steps of the synthesis of cellulose derivative B-1 were appropriately varied to synthesize cellulose derivatives B-2 to B-5 having the substituents in the glucose skeletons listed in Table 2.

### [Synthesis of Cellulose Derivatives B-6 and B-7]

Ethyl cellulose (MED-70 manufactured by Dow Chemical Co. having a degree of substitution of ethoxy groups of 2.35) was selected in place of methyl cellulose that was used in the first step of the synthesis of cellulose derivative B-1, and the ratio of the components and the reaction conditions in the first and second steps of the synthesis of cellulose derivative B-1 were appropriately varied to synthesize cellulose derivatives B-6 and B-7 having the substituents in the glucose skeletons listed in Table 2.

### [Synthesis of Cellulose Derivative B-8]

### (First Step: Synthesis of Cellulose Ether B)

A 60% sodium hydroxide solution (140 g) was added to and mixed with hardwood prehydrolysis kraft pulp containing 98.4% a cellulose (100 g). Bromobutane (380 g) was added, and the mixture was stirred for approximately one hour while the temperature was maintained in the range of 0° C. to 5° C. The mixture was then kept at a temperature within the range 30° C. to 40° C. for six hours for reaction. The content of the mixture was filtered to remove the precipitation. Hot water was added to the filtered solution. After neutralization with 1% phosphoric acid solution, the neutralized solution was added dropwise to acetone to precipitate the reaction product. The reaction product was separated through filtration, washed several times with a 9:1 (volume ratio) solvent of acetone and water, and dried under vacuum at 60° C., to yield butylcellulose. The degree of substitution (MS) of bromobutane in the product was determined to be 1.1 through NMR spectroscopy. The product is referred to as cellulose ether B.

### (Second Step: Thiophene Carboxylation of Cellulose Ether B)

A 3-L three-neck flask with a mechanical stirrer, a thermometer, a condenser tube, and a dropping funnel was charged with cellulose ether B (200 g) prepared in the first step, pyridine (90 mL) and acetone (2000 mL), which were then stirred at room temperature. Thiophene carboxychloride (350 g) was slowly added dropwise to the mixture which was then stirred for eight hours at 50° C. After the reaction, the reactant was cooled to room temperature and then was added to 20 L of methanol while the system was vigorously agitated, to precipitate a white solid. The white solid was suction filtered and rinsed three times with large volumes of methanol. The resulting white solid was dried for one day at 60° C. and dried under vacuum for six hours at 90° C., to obtain cellulose derivative B-8.

The average degree of substitution of the substituents in glucose skeletons of the cellulose derivative B-8 prepared as described above was determined by ¹H-NMR or ¹³C-NMR spectroscopic procedures described in “Cellulose Communication 6, 73-79 (1999)” and “Chirality 12(9), 670-674.” The number of butoxy substituents having ether bonds was 1.0 and the number of thiophene carboxylate substituents having multiple bonds was 1.6; which led to a total degree of substitution of 2.60.

### [Synthesis of Cellulose Derivatives B-9 to B-11]

Cellulose derivatives B-9 to B-11 were prepared as in cellulose derivative B-8, except that the ratio of the components and the reaction conditions in the first and second steps were appropriately varied to synthesize cellulose derivatives having the substituents in the glucose skeletons listed in Table 2.

### <<Production of Retarder Film>>

### [Production of Retarder Films B1 to B11]

Retarder films B1 to B11 were produced as in retarder film A1 according to Example 1, except that cellulose derivatives B-1 to B-11 were used in place of cellulose derivative A-1 and the ratios of solvents used in the preparation of the dope were varied within a range that enables film deposition.

The stretching conditions including the thickness, stretching temperature, and stretching rates in the transverse direction (TD) and machine direction (MD) of the material film were appropriately adjusted such that the in-plane retardation Ro₅₅₀ measured at a wavelength of 550 nm was 140 nm, the film thickness was 50 μm, and Ro₄₅₀/Ro₅₅₀ was the value listed in Table 2.

### <<Production of Circularly Polarizing Plate>>

A polyvinyl alcohol film having a thickness of 120 μm was unidirectionally stretched at a temperature of 110° C. and a stretching rate of 5 times. The stretched film was dipped in a solution containing iodine (0.075 g), potassium iodide (5 g), and water (100 g) for 60 seconds, and then dipped in a solution containing potassium iodide (6 g), boric acid (7.5 g), and water (100 g) at 68° C. The film was washed with water and dried, to yield a polarizer element.

Each retarder film produced in the process described above was bonded to the polarizer element with an adhesive such that the slow axis of the retarder film intersects the absorption axis of the polarizer element at 45°, and a protective film (Konica Minolta TAC film KC4UY having a thickness of 40 μm manufactured by Konica Minolta, Inc.) was bonded to the back side of the polarizer element with a liquid adhesive, to produce circularly polarizing plates B1 to B11.

### <<Production of Organic EL Display Device)

An adhesive was applied to a surface of each retarder film of each circularly polarizing plate B1 to B11 prepared above and bonded to the viewing side of the corresponding organic EL cell according to Example 1, to produce organic EL display devices B1 to B11.

### <<Evaluation of Organic EL Display Device>>

### [Evaluation of Black Tone]

A black image was displayed on each organic EL display device having an intensity of 1000 Lx at 5 cm above the outermost surface of the organic EL display device, under a normal humidity environment of 23° C. and 55% RH.

The color of black display of each organic EL display device was observed from the front (0° to the plane normal) and a 40° degree angle to the plane normal by ten test participants, to evaluate the black tone in accordance with the ranks described below. The black tone was determined to be allowable for use if the evaluation was A or higher.

⊚: nine or ten participants recognized the color of the displayed image as black

⊚ ◯: eight participants recognized the color of the displayed image as black

◯: seven participants recognized the color of the displayed image as black

Δ: five or six participants recognized the color of the displayed image as black

x: four or less participants recognized the color of the displayed image as black

### [Evaluation of Reflectivity]

Organic EL display devices for evaluation were produced as in the organic EL display device described above, except that red, blue, and green lines were drawn with felt pen markers (Magic Inks, registered trademark) to the visible surface of the prepared organic EL cell.

The visibility (reflectivity) of the red, blue, and green felt pen lines on the organic EL display devices having an intensity of 1000 Lx at 5 cm above the outermost surface of the organic EL display device were evaluated under a normal humidity environment of 23° C. and 55% RH by ten test participants in accordance with the ranks described below. The reflectivity was determined to be allowable for use if the evaluation is A or higher. The term “reflectivity” refers to reflection of light at an organic EL cell inside the circularly polarizing plate, not reflection at the surface of the circularly polarizing plate.

⊚: nine or ten participants determined the felt pen lines as being invisible

⊚ ◯: eight participants determined the felt pen lines as being invisible

◯: seven participants determined the felt pen lines as being invisible

Δ: five or six participants determined two of felt pen lines as being invisible

x: four or less participants determined two of felt pens lines as being invisible

The results are listed in Table 2.

TABLE 2

| | | CELLULOSE DERIVATIVE | | | | | |
|---|---|---|---|---|---|---|---|
| ORGANIC | | | SUBSTITUENTS HAVING | | | SUBSTITUENTS HAVING | |
| EL | | | ETHER BONDS | | | MULTIPLE BONDS | |
| DISPLAY | | | *2 | *5 | *1 | *3 | *6 |
| DEVICE | RETARDER | | NUMBER OF | NUMBER OF | NUMBER OF | NUMBER OF | NUMBER OF |
| No. | FILM No. | No. | SUBSTITUENTS | SUBSTITUENTS | SUBSTITUENTS | SUBSTITUENTS | SUBSTITUENTS |
| B1 | B1 | B-1 | 1.8 | 0 | 0 | 0.05 | 0 |
| B2 | B2 | B-2 | 1.8 | 0 | 0 | 0.18 | 0 |
| B3 | B3 | B-3 | 1.8 | 0 | 0 | 0.50 | 0 |
| B4 | B4 | B-4 | 1.8 | 0 | 0 | 0.60 | 0 |
| B5 | B5 | B-5 | 1.8 | 0 | 0 | 0.63 | 0 |
| B6 | B6 | B-6 | 0 | 2.35 | 0 | 0.57 | 0 |
| B7 | B7 | B-7 | 0 | 2.35 | 0 | 0.60 | 0 |
| B8 | B8 | B-8 | 0 | 0 | 1.0 | 0 | 1.60 |
| B9 | B9 | B-9 | 0 | 0 | 1.0 | 0 | 1.70 |
| B10 | B10 | B-10 | 0 | 0 | 1.0 | 0 | 1.80 |
| B11 | B11 | B-11 | 0 | 0 | 1.0 | 0 | 2.00 |

| ORGANIC | CELLULOSE DERIVATIVE | | | | | |
|---|---|---|---|---|---|---|
| EL | OTHER | | | RESULTS | | |
| DISPLAY | SUBSTITUENTS | TOTAL | | OF EVALUATION | | |
| DEVICE | NUMBER OF ACETYL | DEGREE OF | Ro₄₅₀/ | BLACK | | |
| No. | SUBSTITUENTS | SUBSTITUTION | Ro₅₅₀ | TONE | REFLECTIVITY | REMARKS |
| B1 | 0.6 | 2.45 | 1.02 | X | X | COMPATATIVE EXAMPLE |
| B2 | 0.5 | 2.48 | 0.99 | Δ | Δ | PRESENT INVENTION |
| B3 | 0.1 | 2.40 | 0.92 | ◯ | ◯ | PRESENT INVENTION |
| B4 | 0 | 2.40 | 0.86 | ⊚ | ⊚ | PRESENT INVENTION |
| B5 | 0 | 2.47 | 0.82 | ⊚ | ⊚ | PRESENT INVENTION |
| B6 | 0 | 2.92 | 0.87 | ⊚ | ⊚ | PRESENT INVENTION |
| B7 | 0 | 2.95 | 0.84 | ⊚ | ⊚ | PRESENT INVENTION |
| B8 | 0 | 2.60 | 0.80 | ⊚ | ⊚ | PRESENT INVENTION |
| B9 | 0 | 2.70 | 0.77 | ⊚ | ⊚ | PRESENT INVENTION |
| B10 | 0 | 2.80 | 0.73 | ◯ | ◯ | PRESENT INVENTION |
| B11 | 0 | 3.00 | 0.68 | Δ | Δ | PRESENT INVENTION |

*1: BUTOXY GROUP
*2: METHOXY GROUP
*3: BENZOATE GROUP
*5: ETHOXY GROUP
*6: THIOPHENE CARBOXYLATE GROUP

The results in Table 2 demonstrate that organic EL display devices B2 to B11, which have optical films that contain cellulose derivatives having an average degree of substitution of substituents having multiple bonds within the range of 0.1 to 3.0 per glucose skeleton unit, have superior black tone and reflectivity. If the average degree of substitution of the substituents having multiple bonds is not within the range defined in the present invention, the ratio Ro₄₅₀/Ro₅₅₀ will not be a desired value.

### Example 3

### Synthesis of Cellulose Derivative

### [Synthesis of Cellulose Derivatives C-1 to C-5]

Cellulose derivatives C-1 to C-5 were synthesized as in cellulose derivative B-1 described in Example 2, except that thiomethylbenzoyl chloride, methoxybenzoyl chloride, 2,4,5-trimethylbenzoate, 4-pyridinecarbonyl chloride, or 4-methoxycinnamoyl chloride was used in place of benzoyl chloride in the second step, and the volumes of the substances were appropriately modified to achieve the degrees of substitution of substituents (number of substituents) having multiple bonds listed in Table 3.

### [Synthesis of Cellulose Derivative C-6]

A 3-L three-neck flask with a mechanical stirrer, a thermometer, a condenser tube, and a dropping funnel was charged with methyl cellulose having a degree of methoxy substitution of 1.8 (40 g), methylene chloride (500 mL), and pyridine (500 mL), which were then stirred at room temperature. Benzyl chloride (450 g) was slowly added dropwise to the mixture, and then dimethylaminopyridine (DMAP) (approximately 0.1 g) was added. The mixture was then refluxed for three hours. After the reaction, the reactant was cooled to room temperature. While the reactant was being cooled in ice, methanol (100 mL) was added to quench the reactant. The quenched reactant was added to a mixture of methanol (5 L) and water (5 L) while the solution was vigorously agitated, to precipitate a solid. The solid was suction filtered and rinsed three times with large volumes of water. The resulting white solid was dried under vacuum for six hours at 100° C. to obtain cellulose derivative C-6.

### <<Production of Retarder Film>>

### [Production of Retarder Films C1 to C6]

Retarder films C1 to C4 were produced as in retarder film A1 according to Example 1, except that cellulose derivatives C-1 to C-6 were used in place of cellulose derivative A-1.

The stretching conditions including the thickness, stretching temperature, and stretching rates in the transverse direction (TD) and machine direction (MD) of the material film were appropriately adjusted such that the in-plane retardation Ro₅₅₀ measured at a wavelength of 550 nm was 140 nm, the film thickness was 50 μm, and the ratio Ro₄₅₀/Ro₅₅₀ was the value listed in Table 3.

### <<Production of Circularly Polarizing Plate>>

A polyvinyl alcohol film having a thickness of 120 μm was unidirectionally stretched at a temperature of 110° C. and a stretching rate of 5 times. The stretched film was dipped in a solution containing iodine (0.075 g), potassium iodide (5 g), and water (100 g) for 60 seconds, and then dipped in a solution containing potassium iodide (6 g), boric acid (7.5 g), and water (100 g) at 68° C. The film was washed with water and dried, to produce a polarizer element.

Each retarder film produced in the process described above was bonded to the polarizer element with an adhesive such that the slow axis of the retarder film intersects the absorption axis of the polarizer element at 45°, and a protective film (Konica Minolta TAC film KC4UY having a thickness of 40 μm manufactured by Konica Minolta, Inc.) was bonded to the back side of the polarizer element with a liquid adhesive, to produce circularly polarizing plates C1 to C6.

### <<Production of Organic EL Display Device)

An adhesive was applied to a surface of each retarder film of each circularly polarizing plate C1 to C6 prepared above and bonded to the viewing side of the corresponding organic EL cell according to Example 1, to produce organic EL display devices C1 to C6.

### <<Evaluation of Organic EL Display Device>>

Organic EL display devices C1 to C6 prepared above were evaluated for stability against humidity as in the evaluation for those according to Example 1 for Evaluation 1 (evaluation of stability of black tone) and Evaluation 2 (evaluation of stability of reflectivity (visibility)). The results are listed in Table 3.

TABLE 3

| | | CELLULOSE DERIVATIVE | | | | |
|---|---|---|---|---|---|---|
| ORGANIC | | | SUBSTITUENTS | SUBSTITUENTS | | |
| EL | | | HAVING | HAVING | | OTHER |
| DISPLAY | | | ETHER BONDS | MULTIPLE BONDS | | SUBSTITUENTS |
| DEVICE | RETARDER | | NUMBER OF METHOXY | | NUMBER OF | NUMBER OF ACETYL |
| No. | FILM No. | No. | SUBSTITUENTS | TYPE | SUBSTITUENTS | SUBSTITUENTS |
| C1 | C1 | C-1 | 1.8 | *7 | 0.25 | 0.40 |
| C2 | C2 | C-2 | 1.8 | *8 | 0.50 | 0.15 |
| C3 | C3 | C-3 | 1.8 | *4 | 0.60 | 0.05 |
| C4 | C4 | C-4 | 1.8 | *9 | 0.60 | 0.05 |
| C5 | C5 | C-5 | 1.8 | *10 | 0.65 | 0 |
| C6 | C6 | C-6 | 1.8 | *11 | 0.80 | 0 |

| ORGANIC | CELLULOSE | | RESULTS OF EVALUATION | | |
|---|---|---|---|---|---|
| EL | DERIVATIVE | | EVALUATION OF STABILITY | | |
| DISPLAY | TOTAL DEGREE | | AGAINST HUMIDITY | | |
| DEVICE | OF | Ro₄₅₀/ | STABILITY OF | STABILITY OF | |
| No. | SUBSTITUTION | Ro₅₅₀ | BLACK TONE | REFLECTIVITY | REMARKS |
| C1 | 2.45 | 0.87 | ◯ | ◯ | PRESENT INVENTION |
| C2 | 2.45 | 0.89 | ◯ | ◯ | PRESENT INVENTION |
| C3 | 2.45 | 0.85 | ◯ | ◯ | PRESENT INVENTION |
| C4 | 2.45 | 0.85 | ◯ | ◯ | PRESENT INVENTION |
| C5 | 2.45 | 0.92 | ◯ | ◯ | PRESENT INVENTION |
| C6 | 2.60 | 0.86 | ⊚ | ⊚ | PRESENT INVENTION |

*4: 2,4,5-TRIMETHOXYBENZOATE GROUP
*7: THIOMETHYLBENZOATE GROUP
*8: METHOXYBENZOATE GROUP
*9: PYRIDYL CARBOXYLATE GROUP
*10: 4-METHOXYCINNAMATE GROUP
*11: BENZYL GROUP

The results in Table 3 demonstrate that an organic EL display device according to the present invention that contains a cellulose derivative containing substituents having multiple bonds that form ether bonds with glucose skeletons, achieves superior properties.

### Example 4

### Synthesis of Cellulose Derivative

### [Synthesis of Cellulose Derivative D-1]

### (First Step)

A 3-L three-neck flask with a mechanical stirrer, a thermometer, a condenser tube, and a dropping funnel was charged with methyl cellulose having a degree of methoxy substitution of 1.8 (40 g), methylene chloride (500 mL), and pyridine (500 mL), which were then stirred at room temperature. Benzyl chloride (350 g) was slowly added dropwise into the mixture, and dimethylaminopyridine (DMAP) (approximately 0.1 g) was added. The mixture was then refluxed for three hours. After the reaction, the reactant was cooled to room temperature. While the reactant was being cooled in ice, methanol (100 mL) was added to quench the reactant. The quenched reactant was added to a mixture of methanol (5 L) and water (5 L) while the solution was vigorously agitated, to precipitate a solid. The solid was suction filtered and rinsed three times with large volumes of water. The resulting white solid was dried under vacuum for six hours at 100° C. to obtain an intermediate.

### (Second Step)

A 3-L three-neck flask with a mechanical stirrer, a thermometer, a condenser tube, and a dropping funnel was charged with the intermediate (40 g) prepared in the preceding step, methylene chloride (500 mL), and pyridine (500 mL), which were then stirred at room temperature. Acetic anhydride (500 mL) was slowly added dropwise into the mixture, and dimethylaminopyridine (DMAP) (approximately 0.1 g) was added. The mixture was then refluxed for three hours. After the reaction, the reactant was cooled to room temperature. While the reactant was being cooled in ice, methanol (100 mL) was added to quench the reactant. The quenched reactant was added to a mixture of methanol (5 L) and water (5 L) while the solution was vigorously agitated, to precipitate a white solid. The white solid was suction filtered and rinsed three times with large volumes of water. The resulting white solid was dried under vacuum for six hours at 100° C. to obtain cellulose derivative D-1.

The average degree of substitution of the substituents in glucose skeletons of the cellulose derivative D-1 prepared as described above was determined by ¹H-NMR or ¹³C-NMR spectroscopic procedures described in “Cellulose Communication 6, 73-79 (1999)” and “Chirality 12(9), 670-674.” The number of benzoate substituents having multiple bonds was 0.3 for the benzoate substituents at position 6 and 0.3 for the benzoate substituents at positions 2 and 3, the number of acetyl substituents was 0.6, and the number of methoxy substituents having ether bonds was 1.8; which led to a total degree of substitution of 3.0.

### [Synthesis of Cellulose Derivative D-2]

Cellulose derivative D-2 was synthesized as in cellulose derivative D-1, except that the ratio of the components, the hydrolysis, and reaction conditions in the first and second steps were appropriately varied, and the number of benzoate substituents at position 6 was changed to 0.1 and the number of benzoate substituents at positions 2 and 3 to 0.5, and [(average number of substituents at position 2+average number of substituents at position 3)−average number of substituents at position 6] to 0.4.

### <<Production of Retarder Film>>

### [Production of Retarder Films D1 to D2]

Retarder films D1 and D2 were produced as in retarder film A1 according to Example 1, except that cellulose derivatives D-1 and D-2 were used in place of cellulose derivative A-1.

The stretching was performed under the conditions of an in-plane retardation Ro₅₅₀ measured at a wavelength of 550 nm of 140 nm and a film thickness of 50 μm.

### <<Production of Circularly Polarizing Plate>>

A polyvinyl alcohol film having a thickness of 120 μm was unidirectionally stretched at a temperature of 110° C. and a stretching rate of 5 times. The stretched film was dipped in a solution containing iodine (0.075 g), potassium iodide (5 g), and water (100 g) for 60 seconds, and then dipped in a solution containing potassium iodide (6 g), boric acid (7.5 g), and water (100 g) at 68° C. The film was washed with water and dried, to obtain a polarizer element.

Each retarder film produced in the process described above was bonded to the polarizer element with an adhesive such that the slow axis of the retarder film intersects the absorption axis of the polarizer element at 45°, and a protective film (Konica Minolta TAC film KC4UY having a thickness of 40 μm manufactured by Konica Minolta, Inc.) was bonded to the back side of the polarizer element with a liquid adhesive, to produce circularly polarizing plates D1 and D2.

### <<Production of Organic EL Display Device)

An adhesive was applied to a surface of each retarder film of each circularly polarizing plate D1 and D2 prepared above and bonded to the viewing side of the corresponding organic EL cell according to Example 1, to produce organic EL display devices D1 and D2.

### <<Evaluation of Organic EL Display Device>>

Organic EL display devices D1 and D2 produced above were evaluated for black tone and reflectivity as in the evaluations for those according to Example 2. The results are listed in Table 4.

TABLE 4

| | | CELLULOSE DERIVATIVE | | | | | |
|---|---|---|---|---|---|---|---|
| | | | | SUBSTITUENTS | | | |
| ORGANIC | | | SUBSTITUENTS | HAVING MULTIPLE BONDS | | | OTHER |
| EL | | | HAVING | NUMBER OF BENZOATE | | | SUBSTITUENTS |
| DISPLAY | | | ETHER BONDS | SUBSTITUENTS | | (POSITION 2 + | NUMBER OF |
| DEVICE | RETARDER | | NUMBER OF METHOXY | | POSITION 2 + | POSITION 3) − | ACETYL |
| No. | FILM No. | No. | SUBSTITUENTS | POSITION 6 | POSITION 3 | POSITION 6 | SUBSTITUENTS |
| D1 | D1 | D-1 | 1.8 | 0.3 | 0.3 | 0 | 0.6 |
| D2 | D2 | D-2 | 1.8 | 0.1 | 0.5 | 0.4 | 0.6 |

| ORGANIC | CELLULOSE | | | | |
|---|---|---|---|---|---|
| EL | DERIVATIVE | | RESULTS | | |
| DISPLAY | TOTAL | | OF EVALUATION | | |
| DEVICE | DEGREE OF | Ro₄₅₀/ | BLACK | | |
| No. | SUBSTITUTION | Ro₅₅₀ | TONE | REFLECTIVITY | REMARKS |
| D1 | 3.00 | 0.86 | ⊚◯ | ⊚◯ | PRESENT INVENTION |
| D2 | 3.00 | 0.83 | ⊚ | ⊚ | PRESENT INVENTION |

The results in Table 4 demonstrate that an organic EL display device according to the present invention that contains cellulose derivative D-2, which has an average number of substituents having multiple bonds at positions 2, 3, and 6 in the glucose skeletons in the cellulose derivative defined as [0<(average number of substituents at position 2)+(average number of substituents at position 3)−(average number of substituents at position 6)], achieves superior properties. This controls the value Ro₄₅₀/Ro₅₅₀ within the predetermined range, which means the degree of substitution of substituents having multiple bonds can be decreased if the ratio Ro₄₅₀/Ro₅₅₀ remains at the same value. Thus, the costs involving the synthesis can be reduced, and superior cost efficiency can be achieved.

### Example 5

### Synthesis of Cellulose Derivative

### [Synthesis of Cellulose Derivatives E-1 to E-5]

Cellulose derivatives E-1 to E-5 were synthesized as in the synthesis of cellulose derivative A-1 according to Example 1, except that the bromobutane used in the synthesis is substituted with five substituents listed in Table 5 having the different carbon numbers (methoxy, ethoxy, propyloxy, cyclohexyl ether, and octanoxy groups each having a degree of substitution of 2.4), and the step of acetylation is omitted.

### <<Production of Retarder Film>>

### [Production of Retarder Films E1 to E5]

Retarder films E1 to E5 were produced as in retarder film A1 according to Example 1, except that cellulose derivatives E-1 to E-5 were used in place of cellulose derivative A-1.

The stretching conditions including the thickness, stretching temperature, and stretching rates in the transverse direction (TD) and machine direction (MD) of the material film were appropriately adjusted such that the in-plane retardation Ro₅₅₀ measured at a wavelength of 550 nm was 140 nm, the film thickness was 50 μm, and the ratio Ro₄₅₀/Ro₅₅₀ was the value listed in Table 5.

### <<Production of Circularly Polarizing Plate>>

A polyvinyl alcohol film having a thickness of 120 μm was unidirectionally stretched at a temperature of 110° C. and a stretching rate of 5 times. The stretched film was dipped in a solution containing iodine (0.075 g), potassium iodide (5 g), and water (100 g) for 60 seconds, and then dipped in a solution containing potassium iodide (6 g), boric acid (7.5 g), and water (100 g) at 68° C. The film was washed with water and dried, to obtain a polarizer element.

Each retarder film prepared in the process described above was bonded to the polarizer element with an adhesive such that the slow axis of the retarder film intersects the absorption axis of the polarizer element at 45°, and a protective film (Konica Minolta TAC film KC4UY having a thickness of 40 μm manufactured by Konica Minolta, Inc.) was bonded to the back side of the polarizer element with a liquid adhesive, to prepare circularly polarizing plates E1 to E5.

### <<Production of Organic EL Display Device)

An adhesive was applied to a surface of each retarder film of each circularly polarizing plate E1 to E5 prepared above and bonded to the viewing side of the corresponding organic EL cell according to Example 1, to produce organic EL display devices E1 to E5.

### <<Evaluation of Organic EL Display Device>>

Organic EL display devices E1 to E5 produced above were evaluated for stability against humidity as in the evaluation for those according to Example 1 for Evaluation 1 (evaluation of stability of black tone) and Evaluation 2 (evaluation of stability of reflectivity (visibility)), and for black tone and reflectivity through procedures identical to those according to Example 2. The results are listed in Table 5.

TABLE 5

| | | CELLULOSE DERIVATIVE | | | | | |
|---|---|---|---|---|---|---|---|
| ORGANIC | | | SUBSTITUENTS | | SUBSTITUENTS | | |
| EL | | | HAVING | | HAVING | | |
| DISPLAY | | | ETHER BONDS | | MULTIPLE BONDS | TOTAL DEGREE | |
| DEVICE | RETARDER | | | NUMBER OF | NUMBER OF BENZOATE | OF | Ro₄₅₀/ |
| No. | FILM No. | No. | TYPE | SUBSTITUENTS | SUBSTITUENTS | SUBSTITUTION | Ro₅₅₀ |
| E1 | E1 | E-1 | *2 | 2.4 | 0.6 | 3.00 | 0.87 |
| E2 | E2 | E-2 | *5 | 2.4 | 0.6 | 3.00 | 0.88 |
| E3 | E3 | E-3 | *12 | 2.4 | 0.6 | 3.00 | 0.89 |
| E4 | E4 | E-4 | *13 | 2.4 | 0.6 | 3.00 | 0.93 |
| E5 | E5 | E-5 | *14 | 2.4 | 0.6 | 3.00 | 0.96 |

| ORGANIC | RESULTS OF EVALUATION | | | | |
|---|---|---|---|---|---|
| EL | | | EVALUATION OF STABILITY | | |
| DISPLAY | | | AGAINST HUMIDITY | | |
| DEVICE | BLACK | | STABILITY OF | STABILITY OF | |
| No. | TONE | REFLECTIVITY | BLACK TONE | REFLECTIVITY | REMARKS |
| E1 | ⊚ | ⊚ | ⊚ | ⊚ | PRESENT INVENTION |
| E2 | ⊚◯ | ⊚◯ | ⊚ | ⊚ | PRESENT INVENTION |
| E3 | ⊚◯ | ⊚◯ | ⊚ | ⊚ | PRESENT INVENTION |
| E4 | ◯ | ◯ | ⊚ | ⊚ | PRESENT INVENTION |
| E5 | Δ | Δ | ⊚ | ⊚ | PRESENT INVENTION |

*2: METHOXY GROUP (CARBON NUMBER 1)
*5: ETHOXY GROUP (CARBON NUMBER 2)
*12: PROPYLOXY GROUP (CARBON NUMBER 3)
*13: CYCLOHEXYL ETHER GROUP (CARBON NUMBER 5)
*14: OCTANOXY GROUP (CARBON NUMBER 8)

The results in Table 5 demonstrate that the carbon number of the hydroxypropyl groups forming ether bonds with the glucose skeletons of the cellulose derivative in organic EL display devices E1 to E5 according to the present invention is within the range of 1 to 6, which is preferred for achieving the advantages of the present invention.

### (Measurement of Maximum Absorption Wavelength of Substituents Having Multiple Bonds)

The maximum absorption wavelength of the substituents having multiple bonds used in Examples 1 to 5 was measured in the wavelength ranges of 220 to 800 nm with a V-650 spectrometer manufactured by JASCO Inc. The measurements are listed below. The substituents having multiple bonds were bonded with methyl groups and were dissolved in methylene chloride to a concentration that achieve a maximum absorption of 1.0. This solvent was measured for maximum absorption wavelength.

1) Maximum absorption wavelength of benzoate groups: 230 nm
2) Maximum absorption wavelength of thiophene carboxylate groups: 290 nm
3) Maximum absorption wavelength of 2,4,5-trimethylbenzoate groups: 220 nm
4) Maximum absorption wavelength of methoxybenzoate groups: 240 nm
5) Maximum absorption wavelength of pyridyl carboxylate groups: 270 nm
6) Maximum absorption wavelength of 4-methoxycinnamate groups: 310 nm
7) Maximum absorption wavelength of benzyl group: 220 nm

The measurements indicate that the maximum absorption wavelength of 4-methoxycinnamate groups was within the range of 300 to 400 nm, and the maximum absorption wavelength of the other substituents having multiple bonds were within the range of 220 to 300 nm.

### INDUSTRIAL APPLICABILITY

The optical film according to the present invention retards visible light in a wide range by substantially λ/4, exhibits a reduced variation in optical performance (tone and reflectivity) under variable humidity, functions as a superior protective film for a retarder, and is suitable as an optical film (retarder film) for a circularly polarizing plate provided as an antireflective layer in an organic electroluminescent display device.

### EXPLANATION OF REFERENCE NUMERALS

11 stretching direction
13 conveying direction
14 slow axis
D1 feeding direction
D2 reeling direction
F optical film
F1 film roll
F2 stretched film
θi bending angle (feeding angle)
Ci, Co gripper
Ri, Ro rail
Wo width of film before stretching
W width of film after stretching
16 film feeder
17 conveying-direction changer
18 winder
19 film former
A organic electroluminescent display device
B organic electroluminescent element
C circularly polarizing plate
101 transparent substrate
102 metal electrode
103 TFT
104 organic light-emitting layer
105 transparent electrode
106 insulating layer
107 sealing layer
108 film
109 λ/4 retarder film
110 polarizer element
111 protective film
112 cured layer
113 antireflective layer

1. An optical film comprising:
a cellulose derivative, the optical film having an in-plane retardation Ro₅₅₀ within a range of 120 to 160 nm measured at a wavelength of 550 nm, and a ratio Ro₄₅₀/Ro₅₅₀ of in-plane retardations Ro₄₅₀ and Ro₅₅₀ within a range of 0.65 to 0.99 respectively measured at wavelengths of 450 and 550 nm, under an atmosphere of a temperature of 23° C. and a relative humidity of 55%,
wherein,
substituents of glucose skeletons of the cellulose derivative satisfy the following Requirements (a) to (c):
(a) part of the substituents have multiple bonds, and the average degree of substitution of the substituents having multiple bonds is within a range of 0.1 to 3.0 per glucose skeleton unit;
(b) the maximum absorption wavelength of the substituents having multiple bonds is within a range of 220 to 400 nm; and
(c) at least part of the substituents in the glucose skeletons form ether bonds with the glucose skeletons, and the average degree of substitution of the substituents having ether bonds is within a range of 1.0 to 3.0 per glucose skeleton unit.

2. The optical film according to claim 1, wherein the average degree of substitution of the substituents forming ether bonds with the glucose skeletons is within a range of 1.7 to 3.0 per glucose skeleton unit.

3. The optical film according to claim 1, wherein the average degree of substitution of the substituents having multiple bonds is within a range of 0.2 to 3.0 per glucose skeleton unit.

4. The optical film according to claim 1, wherein the average degree of substitution of the substituents having multiple bonds at positions 2, 3, and 6 of the glucose skeletons satisfies Expression (1):
0<(average degree of substitution at position 2+average degree of substitution at position 3)−average degree of substitution at position 6. Expression (1)

5. The optical film according to claim 1, wherein the substituents forming ether bonds with glucose skeletons comprise aliphatic hydrocarbon groups forming ether bonds with the glucose skeletons.

6. The optical film according to claim 5, wherein the aliphatic hydrocarbon groups forming ether bonds with the glucose skeletons comprise nonsubstituted aliphatic hydrocarbon groups having a carbon number within a range of 1 to 6.

7. The optical film according to claim 1, wherein at least part of the substituents forming multiple bonds with the glucose skeletons form ether bonds with the glucose skeletons.

8. The optical film according to claim 1, wherein the substituents having multiple bonds have an aromatic structure.

9. The optical film according to claim 1, wherein the optical film has thickness within a range of 20 to 60 μm.

10. The optical film according to claim 1, wherein the optical film has a large length and a slow axis within a range of 40° to 50° from the longitudinal direction.

11. A circularly polarizing plate comprising:
the optical film according to claim 1 and a polarizer element, the optical film and the polarizer element being bonded together.

12. An organic electroluminescent display device comprising:
the circularly polarizing plate according to claim 11.
